(19) United States
(12) Patent Application Publication
(10) Pub. No.: US 2026/0351823 A1
(43) Pub. Date: Nov. 5, 2026

(54) CIRCULARLY POLARIZED WAVE GENERATOR AND METHOD FOR MANUFACTURING SAME

(71) Applicant: Mitsubishi Electric Corporation, Tokyo (JP)

(72) Inventors: Hidenori YUKAWA, Tokyo (JP); Yu USHIJIMA, Tokyo (JP); Masanari OKAWA, Tokyo (JP); Ryuya SEKI, Tokyo (JP); Tetsuya KATASE, Tokyo (JP); Akimichi HIROTA, Tokyo (JP)

(73) Assignee: Mitsubishi Electric Corporation, Tokyo (JP)

(21) Appl. No.: 19/724,206

(22) Filed: Jun. 29, 2026

Related U.S. Application Data
(63) Continuation of application No. PCT/JP2024/004707, filed on Feb. 13, 2024.

(51) Int. Cl. H01P 1/17; H01P 11/00

(52) U.S. Cl. CPC H01P 1/171; H01P 11/002

(57) ABSTRACT

A circularly polarized wave generator includes: a hollow waveguide having a hollow portion having a circular cross section; and a pair of ridges each having a central axis parallel to a tube axis of the waveguide and arranged in such a manner as to face each other on an inner wall surface of the waveguide. The pair of ridges have first input/output end portions at first ends, second input/output end portions at second ends, and intermediate portions between the first input/output ends and the second input/output ends, respectively. The intermediate portions have protruding portions periodically arranged in a tube axis direction of the waveguide and each protruding in a direction along a line orthogonal to a line connecting central axes of the pair of ridges on a first plane perpendicular to the tube axis of the waveguide, and connecting portions connecting adjacent protruding portions in the protruding portions, respectively.

### CROSS REFERENCE TO RELATED APPLICATION

This application is a Continuation of PCT International Application No. PCT/JP2024/004707, filed on Feb. 13, 2024, which is hereby expressly incorporated by reference into the present application.

### TECHNICAL FIELD

The present disclosure relates to a circularly polarized wave generator mainly used in a VHF band, a UHF band, a microwave band, and a millimeter wave band, and a method for manufacturing the circularly polarized wave generator.

### BACKGROUND ART

Non-Patent Literature 1 discloses a circularly polarized wave generator using a waveguide that outputs a clockwise or counterclockwise circularly polarized wave signal depending on an input polarized wave signal when a vertical linear polarization signal or a horizontal linear polarization signal is input.

The circularly polarized wave generator disclosed in Non-Patent Literature 1 includes fourteen corrugations and five matching steps in a square waveguide.

The fourteen corrugations formed in the waveguide are called ridges.

The circularly polarized wave generator disclosed in Non-Patent Literature 1 is manufactured using wire discharge through a milling process of an aluminum block.

### CITATION LIST

### Non-Patent Literature

Non-Patent Literature 1: Angel Mediavilla et al. “Quasi-Octave Bandwidth Phase Matched K/Ka Antenna Feed Subsystem for dual RHCP/LHCP Polarization,” p.p. 719-722, 2012 EuMA.

### SUMMARY OF INVENTION

### Technical Problem

When the circularly polarized wave generator disclosed in Non-Patent Literature 1 is connected to a horn antenna having a circular waveguide terminal, a converter from a square waveguide to a circular waveguide for connection to the horn antenna is required, which increases the number of components and a length in a tube axis direction.

The present disclosure has been made in view of the points, and an object of the present disclosure is to provide a circularly polarized wave generator that does not increase a length in a tube axis direction even when the circularly polarized wave generator is connected to a horn antenna having a circular waveguide terminal and has a favorable reflection characteristic and axial ratio characteristic.

### Solution to Problem

A circularly polarized wave generator according to the present disclosure includes: a hollow waveguide having a first input/output terminal at a first end, a second input/output terminal at a second end, and a hollow portion having a circular cross section; and a pair of ridges each having a central axis parallel to a tube axis of the waveguide and arranged in such a manner as to face each other on an inner wall surface of the waveguide. Each of the pair of ridges has a first input/output end portion at a first end, a second input/output end portion at a second end, and an intermediate portion between the first input/output end portion and the second input/output end portion. The intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions, wherein each of the plurality of protruding portions has a rectangular cross section parallel to a third plane orthogonal to a second plane including central axes of the pair of ridges.

### ADVANTAGEOUS EFFECTS OF INVENTION

According to the present disclosure, a connection to a horn antenna having a circular waveguide terminal can be made with a favorable reflection characteristic and axial ratio characteristic without increasing a length in a tube axis direction.

### BRIEF DESCRIPTION OF DRAWINGS

FIG. 1 is a perspective view illustrating a pair of ridges as a main part while a waveguide is seen through in a circularly polarized wave generator according to a first embodiment.

FIG. 2 is a side view illustrating the pair of ridges as a main part while the waveguide is seen through in the circularly polarized wave generator according to the first embodiment, as viewed from a direction of a line connecting central axes of the pair of ridges.

FIG. 3 is a side view illustrating the pair of ridges as a main part while the waveguide is seen through in the circularly polarized wave generator according to the first embodiment, as viewed from a direction orthogonal to a line connecting central axes of the pair of ridges.

FIG. 4 is a perspective view illustrating the pair of ridges in the circularly polarized wave generator according to the first embodiment.

FIG. 5 is a side view illustrating the pair of ridges in the circularly polarized wave generator according to the first embodiment, as viewed from a direction of a line connecting central axes of the pair of ridges.

FIG. 6 is a perspective view illustrating an electric field direction in a state where a horizontal linear polarization signal (X polarization signal) and a vertical linear polarization signal (Y polarization signal) are input to one waveguide input/output terminal and corresponding to FIG. 1 in the circularly polarized wave generator according to the first embodiment.

FIG. 7 is a side view schematically illustrating the pair of ridges in the circularly polarized wave generator according to the first embodiment, as viewed from a direction of a line connecting central axes of the pair of ridges and from a direction orthogonal thereto.

FIG. 8 is a cross-sectional view schematically illustrating electric field directions of two linear polarization signals in A-A cross section and B-B cross section in FIG. 7 in the circularly polarized wave generator according to the first embodiment.

FIG. 9 is a perspective view illustrating a structure representatively illustrating one protrusion on each of the pair of ridges facing each other in the circularly polarized wave generator according to the first embodiment.

FIG. 10 is a diagram illustrating a phase characteristic in the circularly polarized wave generator according to the first embodiment.

FIG. 11 is a diagram illustrating a reflection characteristic in the circularly polarized wave generator according to the first embodiment.

FIG. 12 is a side view schematically illustrating a pair of ridges in a circularly polarized wave generator according to a reference example, as viewed from a direction of a line connecting central axes of the pair of ridges and from a direction orthogonal thereto.

FIG. 13 is a cross-sectional view schematically illustrating electric field directions of two linear polarization signals in A-A cross section and B-B cross section in FIG. 7 in the circularly polarized wave generator according to the reference example.

FIG. 14 is a perspective view illustrating a structure representatively illustrating one protrusion on each of the pair of ridges facing each other in the circularly polarized wave generator according to the reference example.

FIG. 15 is a diagram illustrating a phase characteristic in the circularly polarized wave generator according to the reference example.

FIG. 16 is a diagram illustrating a reflection characteristic in the circularly polarized wave generator according to the reference example.

FIG. 17 is a perspective view illustrating a pair of ridges as a main part while a waveguide is seen through in a circularly polarized wave generator according to a second embodiment.

FIG. 18 is a side view illustrating the pair of ridges as a main part while the waveguide is seen through in the circularly polarized wave generator according to the second embodiment, as viewed from a direction of a line connecting central axes of the pair of ridges.

FIG. 19 is a side view illustrating the pair of ridges as a main part while the waveguide is seen through in the circularly polarized wave generator according to the second embodiment, as viewed from a direction orthogonal to a line connecting central axes of the pair of ridges.

FIG. 20 is a perspective view illustrating the pair of ridges in the circularly polarized wave generator according to the second embodiment.

FIG. 21 is a side view illustrating the pair of ridges in the circularly polarized wave generator according to the second embodiment, as viewed from a direction of a line connecting central axes of the pair of ridges.

FIG. 22 is a perspective view illustrating a pair of ridges as a main part while a waveguide is seen through in a circularly polarized wave generator according to a third embodiment.

FIG. 23 is a side view illustrating the pair of ridges as a main part while the waveguide is seen through in the circularly polarized wave generator according to the third embodiment, as viewed from a direction of a line connecting central axes of the pair of ridges.

FIG. 24 is a side view illustrating the pair of ridges as a main part while the waveguide is seen through in the circularly polarized wave generator according to the third embodiment, as viewed from a direction orthogonal to a line connecting central axes of the pair of ridges.

FIG. 25 is a perspective view illustrating the pair of ridges in the circularly polarized wave generator according to the third embodiment.

FIG. 26 is a side view illustrating the pair of ridges in the circularly polarized wave generator according to the third embodiment, as viewed from a direction of a line connecting central axes of the pair of ridges.

FIG. 27 is a perspective view illustrating a pair of ridges as a main part while a waveguide is seen through in a circularly polarized wave generator according to a fourth embodiment.

FIG. 28 is a side view illustrating the pair of ridges as a main part while the waveguide is seen through in the circularly polarized wave generator according to the fourth embodiment, as viewed from a direction of a line connecting central axes of the pair of ridges.

FIG. 29 is a side view illustrating the pair of ridges as a main part while the waveguide is seen through in the circularly polarized wave generator according to the fourth embodiment, as viewed from a direction orthogonal to a line connecting central axes of the pair of ridges.

FIG. 30 is a perspective view illustrating the pair of ridges in the circularly polarized wave generator according to the fourth embodiment.

FIG. 31 is a side view illustrating the pair of ridges in the circularly polarized wave generator according to the fourth embodiment, as viewed from a direction of a line connecting central axes of the pair of ridges.

FIG. 32 is a perspective view illustrating a pair of ridges as a main part while a waveguide is seen through in a circularly polarized wave generator according to a fifth embodiment.

FIG. 33 is a side view illustrating the pair of ridges as a main part while the waveguide is seen through in the circularly polarized wave generator according to the fifth embodiment, as viewed from a direction of a line connecting central axes of the pair of ridges.

FIG. 34 is a side view illustrating the pair of ridges as a main part while the waveguide is seen through in the circularly polarized wave generator according to the fifth embodiment, as viewed from a direction orthogonal to a line connecting central axes of the pair of ridges.

FIG. 35 is a perspective view illustrating a pair of second ridges in the circularly polarized wave generator according to the fifth embodiment.

FIG. 36 is a perspective view illustrating a pair of ridges as a main part while a waveguide is seen through in a circularly polarized wave generator according to a sixth embodiment.

FIG. 37 is a side view illustrating the pair of ridges as a main part while the waveguide is seen through in the circularly polarized wave generator according to the sixth embodiment, as viewed from a direction of a line connecting central axes of the pair of ridges.

FIG. 38 is a side view illustrating the pair of ridges as a main part while the waveguide is seen through in the circularly polarized wave generator according to the sixth embodiment, as viewed from a direction orthogonal to a line connecting central axes of the pair of ridges.

FIG. 39 is a perspective view illustrating a pair of ridges as a main part while a waveguide is seen through in a circularly polarized wave generator according to a seventh embodiment.

FIG. 40 is a side view illustrating the pair of ridges as a main part while the waveguide is seen through in the circularly polarized wave generator according to the seventh embodiment, as viewed from a direction of a line connecting central axes of the pair of ridges.

FIG. 41 is a side view illustrating the pair of ridges as a main part while the waveguide is seen through in the circularly polarized wave generator according to the seventh embodiment, as viewed from a direction orthogonal to a line connecting central axes of the pair of ridges.

FIG. 42 is a perspective view illustrating a pair of ridges as a main part while a waveguide is seen through in a circularly polarized wave generator according to an eighth embodiment.

FIG. 43 is a side view illustrating the pair of ridges as a main part while the waveguide is seen through in the circularly polarized wave generator according to the eighth embodiment, as viewed from a direction of a line connecting central axes of the pair of ridges.

FIG. 44 is a side view illustrating the pair of ridges as a main part while the waveguide is seen through in the circularly polarized wave generator according to the eighth embodiment, as viewed from a direction orthogonal to a line connecting central axes of the pair of ridges.

FIG. 45 is a perspective view illustrating a pair of second ridges in the circularly polarized wave generator according to the eighth embodiment.

FIG. 46 is a side view illustrating the pair of second ridges in the circularly polarized wave generator according to the eighth embodiment, as viewed from a direction orthogonal to a line connecting central axes of the pair of second ridges.

### DESCRIPTION OF EMBODIMENTS

### First Embodiment

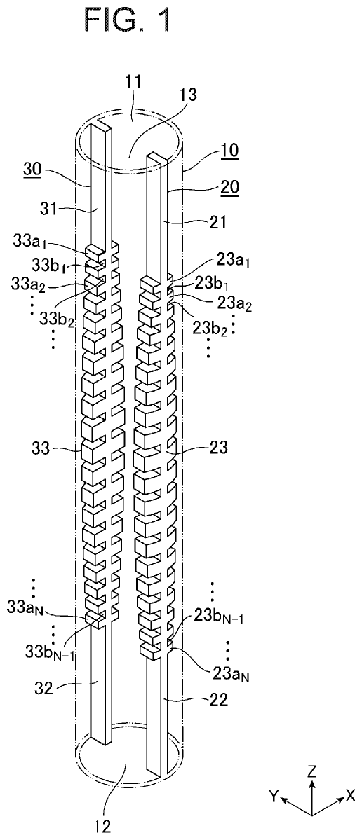

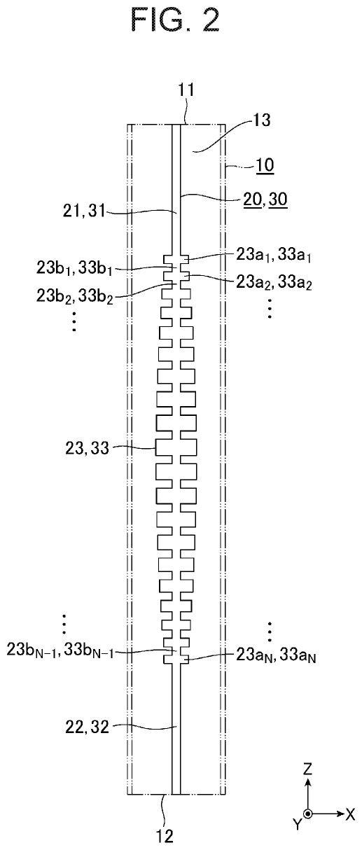

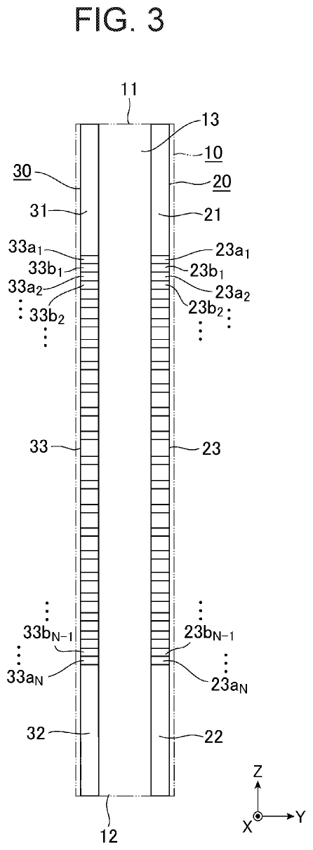

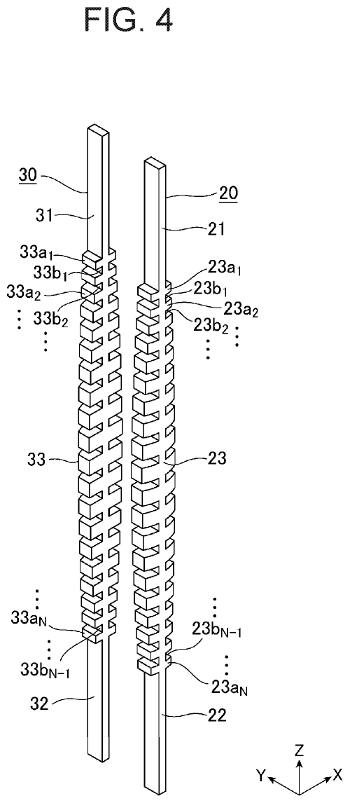

A circularly polarized wave generator according to a first embodiment will be described with reference to FIGS. 1 to 11.

The circularly polarized wave generator is used mainly in a VHF band, a UHF band, a microwave band, and a millimeter wave band, and is connected to a horn antenna having a circular waveguide terminal.

In the circularly polarized wave generator, when two linear polarization signals orthogonal to each other, that is, a vertical linear polarization signal and a horizontal linear polarization signal are input, a phase difference of 90 degrees is generated between the two linear polarization signals orthogonal to each other and is output.

According to this principle, in a circularly polarized wave generator including a circular waveguide having a first input/output terminal at a first end and a second input/output terminal at a second end, and a pair of ridges each having a central axis parallel to a tube axis of the waveguide and arranged in such a manner as to face each other on an inner wall surface of the waveguide, for example, when a linear polarization signal inclined by 45 degrees to the right with respect to a line segment connecting the pair of ridges is input, a clockwise circular polarization signal is output from the second input/output terminal, and when a linear polarization signal inclined by 45 degrees to the left with respect to the line segment connecting the pair of ridges is input, a counterclockwise circular polarization signal is output from the second input/output terminal.

The circularly polarized wave generator includes a circular waveguide 10 and a pair of ridges 20 and 30.

The waveguide 10 is a hollow cylindrical waveguide having a circular first input/output terminal 11 at a first end, a circular second input/output terminal 12 at a second end, and a hollow portion 13 having a circular cross section.

In the waveguide 10, the hollow portion 13 constitutes a waveguide path through which an electromagnetic wave is propagated, a first end of the waveguide path constitutes the first input/output terminal 11, and a second end of the waveguide path constitutes the second input/output terminal 12.

The second input/output terminal 12 is connected to a circular waveguide terminal of a horn antenna (not illustrated).

A circularly polarized signal output from the second input/output terminal 12 is propagated to the horn antenna via the circular waveguide terminal of the horn antenna, and a signal by an electromagnetic wave is emitted from the horn antenna into the air.

Note that, in the following description, an axis parallel to the tube axis of the waveguide 10 is defined as a Z axis, a horizontal plane perpendicular to the tube axis of the waveguide 10 is defined as a first plane, and two axes orthogonal to each other on the first plane are defined as an X axis and a Y axis. That is, the first plane is an X-Y plane centered on the tube axis of the waveguide 10 in the first embodiment.

The pair of ridges 20 and 30 each have a central axis parallel to the tube axis of the waveguide 10 and are arranged in such a manner as to face each other on an inner wall surface of the waveguide 10.

The pair of ridges 20 and 30 has a symmetrical structure with respect to a third plane that is a vertical plane parallel to the tube axis of the waveguide 10, the vertical plane passing through the tube axis that is a central axis of the waveguide 10.

The third plane is an X-Z plane including the tube axis of the waveguide 10 in the first embodiment, and is a plane orthogonal to a line connecting central axes of the pair of ridges 20 and 30.

In the first embodiment, a plane including the tube axis of the waveguide 10 and a line connecting the central axes of the pair of ridges 20 and 30 is defined as a Y-Z plane, which is referred to as a second plane.

The pair of ridges 20 and 30 is integrated with the waveguide 10.

The pair of ridges 20 and 30 have the first input/output end portions 21 and 31 at a first end, the second input/output end portions 22 and 32 at a second end, and the intermediate portions 23 and 33 between the first input/output end portions 21 and 31 and the second input/output end portions 22 and 32, respectively.

The lengths of the first input/output end portions 21 and 31 in a direction (Y-axis direction) along a line connecting the central axes of the pair of ridges 20 and 30 are uniform over the entire length, and the lengths of the first input/output end portions 21 and 31 in a direction (X-axis direction) along a line orthogonal to the line connecting the central axes of the pair of ridges 20 and 30 are uniform over the entire length.

Hereinafter, a length in the X-axis direction is referred to as a lateral width, a length in the Y-axis direction is referred to as a height, and a length in the Z-axis direction is referred to as a longitudinal width.

That is, in each of the first input/output end portions 21 and 31, the lateral width is uniform over the entire length in the Z-axis direction, and the height is uniform over the entire length in the Z-axis direction.

A boundary surface between each of the first input/output end portions 21 and 31 and an inner wall surface of the waveguide 10 is an arc surface along the inner wall surface of the waveguide 10 with respect to the X-Z plane.

A facing surface facing the boundary surface in each of the first input/output end portions 21 and 31 is rectangular and is a plane parallel to the X-Z plane.

The first input/output end portion 21 and the first input/output end portion 31 have the same size and the same shape.

In each of the second input/output end portions 22 and 32, the lateral width is uniform over the entire length in the Z-axis direction, and the height is uniform over the entire length in the Z-axis direction.

A boundary surface between each of the second input/output end portions 22 and 32 and an inner wall surface of the waveguide 10 is an arc surface along the inner wall surface of the waveguide 10 with respect to the X-Z plane.

A facing surface facing the boundary surface in each of the second input/output end portions 22 and 32 is rectangular and is a plane parallel to the X-Z plane.

The second input/output end portion 22 and the second input/output end portion 32 have the same size and the same shape.

In the ridge 20, the facing surface in the first input/output end portion 21 and the facing surface in the second input/output end portion 22 are on the same X-Z plane.

In the ridge 30, the facing surface in the first input/output end portion 31 and the facing surface in the second input/output end portion 32 are on the same X-Z plane.

The intermediate portions 23 and 33 have a plurality of protruding portions 23a₁ to 23a_{N} and 33a₁ to 33a_{N} periodically arranged in the tube axis direction of the waveguide 10, that is, in the Z-axis direction, and connecting portions 23b₁ to 23b_{N-1} and 33b₁ to 33b_{N-1} connecting adjacent protruding portions in the plurality of protruding portions 23a₁ to 23a_{N} and 33a₁ to 33a_{N}, respectively.

The plurality of protruding portions 23a₁ to 23a_{N} and 33a₁ to 33a_{N} protrude from the connecting portions 23b₁ to 23b_{N} and 33b₁ to 33b_{N} in a direction along a line orthogonal to a line connecting the central axes of the pair of ridges 20 and 30, that is, in the X-axis direction on the first plane perpendicular to the tube axis of the waveguide 10, that is, on the X-Y plane, respectively.

Each of the plurality of protruding portions 23a₁ to 23a_{N} and 33a₁ to 33a_{N} has a rectangular cross section parallel to the third plane which is the X-Z plane.

A length of each of the plurality of protruding portions 23a₁ to 23a_{N}, in a direction (X-axis direction) along a line orthogonal to a line connecting the central axes of the pair of ridges 20 and 30, that is, a lateral width W becomes sequentially shorter as it goes from a protruding portion at a center of the central axis of the ridge 20 toward each of the first input/output end portion 21 and the second input/output end portion 22.

The protruding portion at the center of the central axis of the ridge 20 is a protruding portion 23a_{(N+1)/2} when N is an odd number, and is 23a_{N/2} and 23a_{(N+2)/2} when N is an even number.

The following description will be made by assuming that the protruding portion at the center is the protruding portion 23a_{N/2}.

A lateral width Wₙ (n is 1 to N) in the plurality of protruding portions 23a₁ to 23a_{N} has the following relationship in the first embodiment.

W₁<W₂<. . . <W_{(N-2)/2}<W_{N/2}>W_{(N+2)/2}>. . . >W_{N-1}>W_{N}

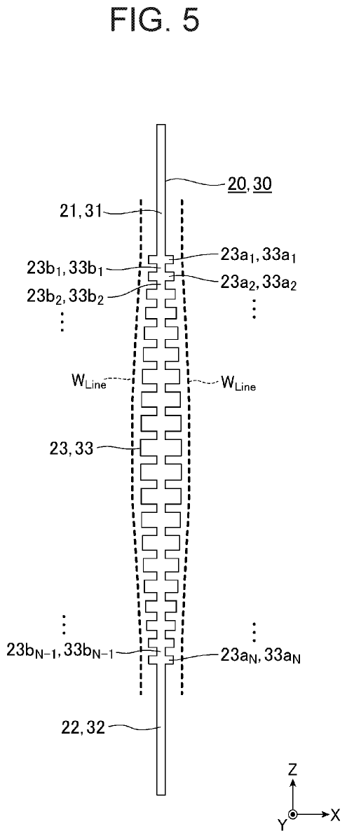

As indicated by a broken line W_{Line} in FIG. 5, the relationship of the lateral width Wₙ in the plurality of protruding portions 23a₁ to 23a_{N} preferably becomes shorter in a trigonometric function shape as it is closer to the first input/output end portion 21 and the second input/output end portion 22 with the protruding portion 23a_{N/2} at the center as a vertex.

By changing the lateral width Wₙ in the plurality of protruding portions 23a₁ to 23a_{N} in a trigonometric function shape, the shape changes gently, and therefore a more favorable reflection characteristic can be achieved.

In the plurality of protruding portions 23a₁ to 23a_{N}, a length in the Z-axis direction, that is a longitudinal width L becomes sequentially shorter as it goes from the protruding portion 23a_{N/2} at the center of the central axis of the ridge 20 toward each of the first input/output end portion 21 and the second input/output end portion 22.

A longitudinal width Lₙ in the plurality of protruding portions 23a₁ to 23a_{N} has the following relationship in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

In the plurality of protruding portions 23a₁ to 23a_{N}, lengths in a direction (Y-axis direction) along a line connecting the central axes of the pair of ridges 20 and 30, that is, the heights H are the same.

A boundary surface between each of the plurality of protruding portions 23a₁ to 23a_{N} and an inner wall surface of the waveguide 10 is an arc surface along the inner wall surface of the waveguide 10 with respect to the X-Z plane.

A facing surface facing the boundary surface in the plurality of protruding portions 23a₁ to 23a_{N} is rectangular and is a plane parallel to the X-Z plane.

In the ridge 20, the facing surfaces in the plurality of protruding portions 23a₁ to 23a_{N} are on the same X-Z plane as the facing surface in the first input/output end portion 21 and the facing surface in the second input/output end portion 22.

In the plurality of protruding portions 33a₁ to 33a_{N}, a lateral width W becomes sequentially shorter as it goes from a protruding portion at a center of the central axis of the ridge 30 toward each of the first input/output end portion 31 and the second input/output end portion 32.

A lateral width Wₙ (n is 1 to N) in the plurality of protruding portions 33a₁ to 33a_{N} has the following relationship.

W₁<W₂<. . . <W_{(N-2)/2}<W_{N/2}>W_{(N+2)/2}>. . . >W_{N-1}>W_{N}

As indicated by a broken line W_{Line} in FIG. 5, the relationship of the lateral width Wₙ in the plurality of protruding portions 33a₁ to 33a_{N} preferably becomes shorter in a trigonometric function shape as it is closer to the first input/output end portion 31 and the second input/output end portion 32 with the protruding portion 33a_{N/2} at the center as a vertex.

In the plurality of protruding portions 33a₁ to 33a_{N}, a longitudinal width L becomes sequentially shorter as it goes from the protruding portion 33a_{N/2} at the center of the central axis of the ridge 30 toward each of the first input/output end portion 31 and the second input/output end portion 32.

A longitudinal width Lₙ in the plurality of protruding portions 33a₁ to 33a_{N} has the following relationship in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

The plurality of protruding portions 33a₁ to 33a_{N} have the same height H.

A boundary surface between each of the plurality of protruding portions 33a₁ to 33a_{N} and an inner wall surface of the waveguide 10 is an arc surface along the inner wall surface of the waveguide 10 with respect to the X-Z plane.

A facing surface facing the boundary surface in the plurality of protruding portions 33a₁ to 33a_{N} is rectangular and is a plane parallel to the X-Z plane.

In the ridge 30, the facing surfaces in the plurality of protruding portions 33a₁ to 33a_{N} are on the same X-Z plane as the facing surface in the first input/output end portion 31 and the facing surface in the second input/output end portion 32.

Each of the connecting portions 23b₁ to 23b_{N-1} and 33b₁ to 33b_{N-1} has a rectangular cross section parallel to the third plane which is the X-Z plane.

The connecting portions 23b₁ to 23b_{N-1} have the same length in the X-axis direction, that is, the same lateral width W₀, and the lateral width W₀ is shorter than minimum lateral widths W₁ and W_{N} in the protruding portions 23a₁ to 23a_{N} and is the same as the lateral width of the first input/output end portion 21 and the lateral width of the second input/output end portion 22.

The connecting portions 23b₁ to 23b_{N-1} have the same length in the Z-axis direction, that is, the same longitudinal width L₀, and arrange the protruding portions 23a₁ to 23a_{N} at equal intervals.

A boundary surface between each of the connecting portions 23b₁ to 23b_{N-1} and an inner wall surface of the waveguide 10 is an arc surface along the inner wall surface of the waveguide 10 with respect to the X-Z plane.

A facing surface facing the boundary surface in each of the connecting portions 23b₁ to 23b_{N-1} is rectangular and is a plane parallel to the X-Z plane.

In the ridge 20, the facing surface in each of the connecting portions 23b₁ to 23b_{N-1} is on the same X-Z plane as the facing surface in the first input/output end portion 21 and the facing surface in the second input/output end portion 22 and the facing surfaces in the plurality of protruding portions 23a₁ to 23a_{N}.

That is, the facing surface facing the arc surface along the inner wall surface of the waveguide 10 in the ridge 20 is a plane on the X-Z plane.

The connecting portions 33b₁ to 33b_{N-1} have the same length in the X-axis direction, that is, the same lateral width W₀, and the lateral width W₀ is shorter than minimum lateral widths W₁ and W_{N} in the protruding portions 33a₁ to 33a_{N} and is the same as the lateral width of the first input/output end portion 31 and the lateral width of the second input/output end portion 32.

The connecting portions 33b₁ to 33b_{N-1} have the same length in the Z-axis direction, that is, the same longitudinal width L₀, and arrange the protruding portions 33a₁ to 33a_{N} at equal intervals.

A boundary surface between each of the connecting portions 33b₁ to 33b_{N-1} and an inner wall surface of the waveguide 10 is an arc surface along the inner wall surface of the waveguide 10 with respect to the X-Z plane.

A facing surface facing the boundary surface in each of the connecting portions 33b₁ to 33b_{N-1} is rectangular and is a plane parallel to the X-Z plane.

In the ridge 30, the facing surface in each of the connecting portions 33b₁ to 33b_{N-1} is on the same X-Z plane as the facing surface in the first input/output end portion 31 and the facing surface in the second input/output end portion 32 and the facing surfaces in the plurality of protruding portions 33a₁ to 33a_{N}.

That is, the facing surface facing the arc surface along the inner wall surface of the waveguide 10 in the ridge 30 is a plane on the X-Z plane.

The facing surface in the ridge 20 and the facing surface in the ridge 30 face each other.

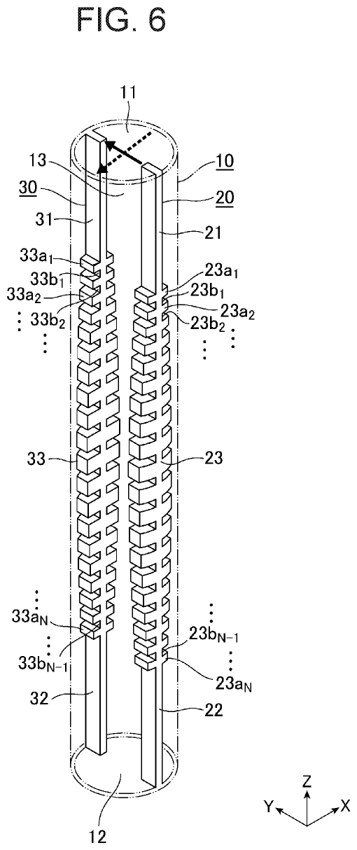

Next, a case where two linear polarization signals orthogonal to each other are input to the first input/output terminal 11 of the waveguide tube 10 as indicated by a solid line and a broken line in FIG. 6 in the circularly polarized wave generator according to the first embodiment will be described.

The linear polarization signal indicated by the broken line is a horizontal linear polarization signal indicating a direction of an electric field of an electromagnetic wave in the X-axis direction, and the linear polarization signal indicated by the solid line is a vertical linear polarization signal indicating a direction of an electric field of an electromagnetic wave in the Y-axis direction.

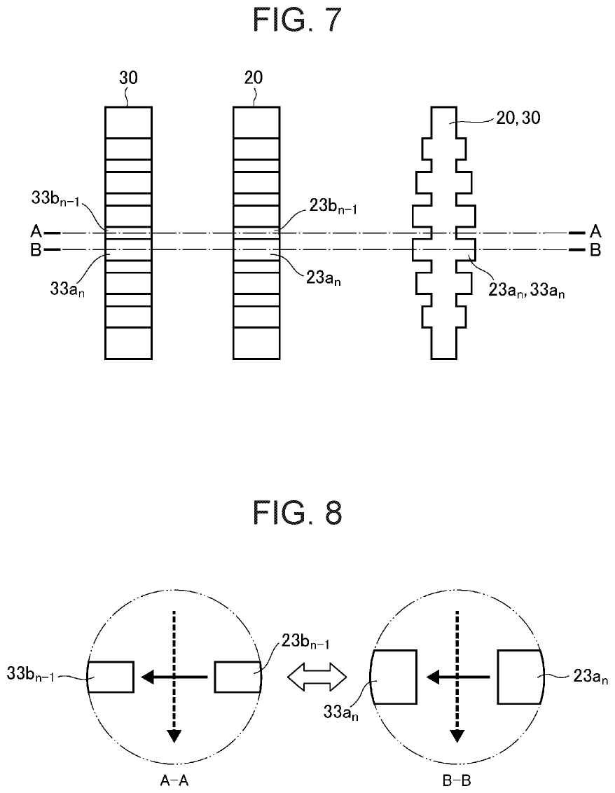

FIG. 8 illustrates electric fields of electromagnetic waves in a B-B cross section of the X-Y plane in protruding portions 23aₙ and 33aₙ having a lateral width Wₙ and in an A-A cross section of the X-Y plane in connecting portions 23bₙ₋₁ and 33bₙ₋₁ having a lateral width W₀, illustrated in FIG. 7.

The ridges 20 and 30 in the circularly polarized wave generator according to the first embodiment are formed by periodically changing the lateral width in the tube axis direction of the waveguide 10. For example, a phase difference is generated in an electromagnetic wave propagated through a waveguide path due to a periodic structure in which the lateral width is narrow in the A-A cross section and the lateral width is wide in the B-B cross section.

In addition, since the ridges 20 and 30 in the circularly polarized wave generator according to the first embodiment have periodic structures in which the protruding portions 23a₁ to 23a_{N} and 33a₁ to 33a_{N} having different lateral widths are periodically arranged, respectively, a desired phase difference is obtained in a desired frequency band by appropriately selecting the lateral widths W of the protruding portions 23a₁ to 23a_{N} and 33a₁ to 33a_{N}, and a desired axial ratio characteristic can be achieved.

As a result, in the circularly polarized wave generator according to the first embodiment, by appropriately designing the shapes of the plurality of protruding portions 23a₁ to 23a_{N} and 33a₁ to 33a_{N} in the ridges 20 and 30, particularly the lateral width W, a desired phase difference is obtained in selected frequency bands mainly in a VHF band, a UHF band, a microwave band, and a millimeter wave band, and a circularly polarized wave signal in which a desired axial ratio characteristic is achieved is obtained.

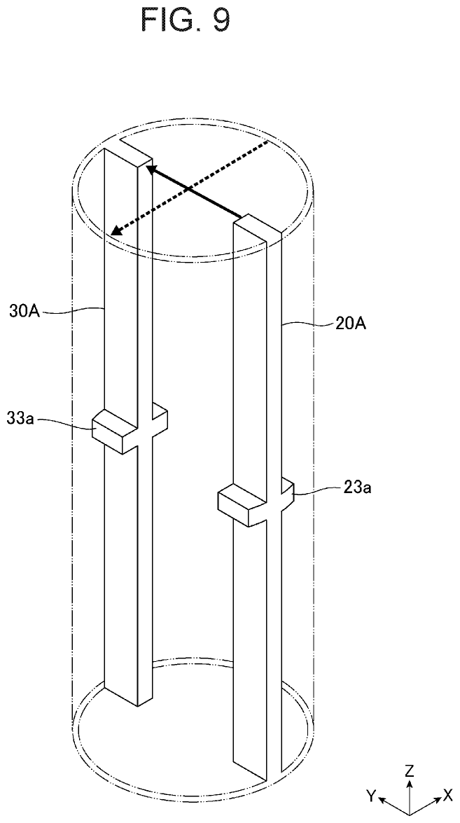

Verification results of a passing characteristic of a linear polarization signal, a phase characteristic that is a so-called passing phase difference between two linear polarization signals, and a reflection characteristic, obtained by electromagnetic field analysis in the circularly polarized wave generator according to the first embodiment will be described with reference to FIGS. 9 to 11.

FIG. 9 illustrates a structure in which one protrusion 23a and one protrusion 33a are illustrated on a pair of ridges 20A and 30A facing each other, respectively.

In FIG. 9, a broken line indicates a direction of an electric field of an electromagnetic wave of a horizontal linear polarization signal, and a solid line indicates a direction of an electric field of an electromagnetic wave of a vertical linear polarization signal.

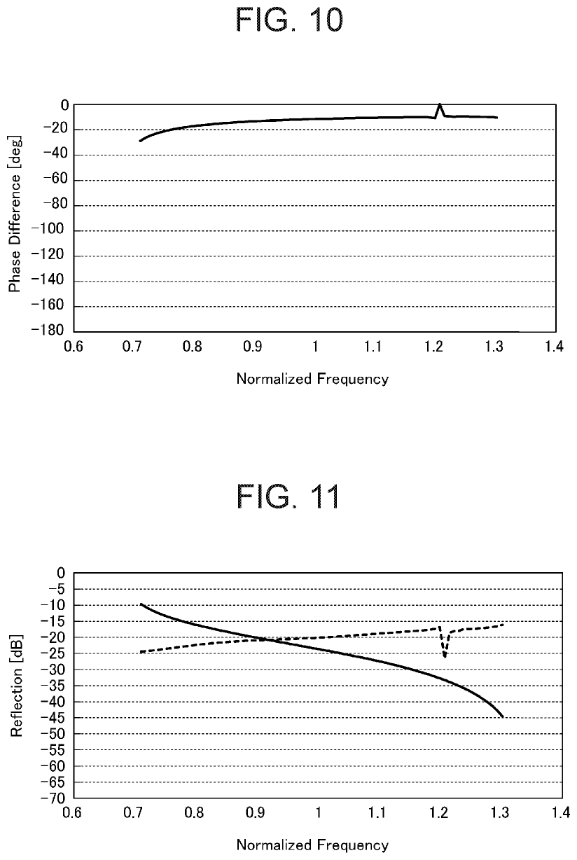

FIG. 10 illustrates a verification result for a phase characteristic that is a pass phase difference with respect to a normalized frequency obtained by electromagnetic field analysis with a structure in which the protrusions 23a and 33a illustrated in FIG. 9 are formed on the pair of ridges 20A and 30A, respectively, and FIG. 11 illustrates a verification result for a reflection characteristic that is a transmission line characteristic with respect to a normalized frequency obtained by electromagnetic field analysis.

In FIG. 10, a horizontal axis represents a normalized frequency, and a vertical axis represents a phase difference.

In FIG. 11, a horizontal axis represents a normalized frequency, a vertical axis represents a reflection coefficient, a broken line represents a reflection characteristic by a horizontal linear polarization signal, and a solid line represents a reflection characteristic by a vertical linear polarization signal.

When a phase difference between two linear polarization signals orthogonal to each other due to the structure in which one protrusion 23a and one protrusion 33a are formed on the pair of ridges 20A and 30A facing each other, respectively, is set to about 10 deg as illustrated in FIG. 10, reflection characteristics of the two linear polarization signals orthogonal to each other are substantially at the same level as illustrated in FIG. 11.

Therefore, a difference in a passage loss between the two linear polarization signals orthogonal to each other is reduced.

By connecting a plurality of protrusions 23a and a plurality of protrusions 33a to the pair of ridges 20A and 30A, respectively, a phase difference between the two linear polarization signals orthogonal to each other can be set to 90 deg.

Even in a case where the phase difference between the two linear polarization signals orthogonal to each other is set to 90 deg by connecting a plurality of protrusions 23a and 33a, as can be understood from the reflection characteristics illustrated in FIG. 11, the reflection characteristics of the two linear polarization signals orthogonal to each other are substantially at the same level, and the difference in a passage loss between the two linear polarization signals orthogonal to each other is reduced.

In order to achieve a favorable axial ratio characteristic, it is desirable that passage amplitudes of the two linear polarization signals orthogonal to each other are the same and passage phases thereof have a desired difference. As can be understood from FIGS. 10 and 11, the circularly polarized wave generator according to the first embodiment achieves a favorable axial ratio characteristic.

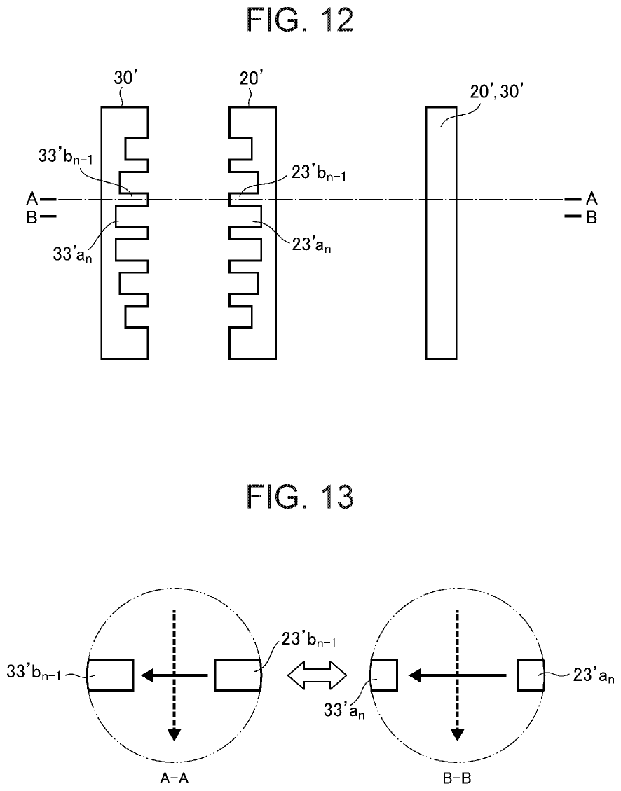

Hereinafter, for comparison with the circularly polarized wave generator according to the first embodiment, a circularly polarized wave generator in which a pair of ridges 20′ and 30′ facing each other have comb shapes having grooves 23′a₁ to 23′a_{N} and 33′a₁ to 33′a_{N} extending from facing surfaces toward an inner wall surface of the waveguide, respectively, will be described as a reference example with reference to FIGS. 12 to 16.

As a structure of the pair of ridges 20′ and 30′ in the reference example, as illustrated in FIG. 12, facing surfaces of the pair of ridges 20′ and 30′ are located on a plane parallel to the X-Z plane, and have comb shapes having grooves 23′a₁ to 23′a_{N} and 33′a₁ to 33′a_{N} extending from the facing surfaces to an inner wall surface of the waveguide.

FIG. 13 illustrates electric fields of electromagnetic waves in a B-B cross section of the X-Y plane in grooves 23′aₙ and 33′aₙ having a depth Dₙ and in an A-A cross section of the X-Y plane in facing surfaces 23′bₙ₋₁ and 33′bₙ₋₁ having a height H and adjacent to the grooves 23′aₙ and 33′aₙ, illustrated in FIG. 12.

In FIG. 13, a broken line indicates a direction of an electric field of an electromagnetic wave of a horizontal linear polarization signal, and a solid line indicates a direction of an electric field of an electromagnetic wave of a vertical linear polarization signal.

Also in the circularly polarized wave generator according to the reference example, the ridges 20′ and 30′ periodically change depths Dₙ of the grooves 23′aₙ and 33′aₙ in the tube axis direction of the waveguide 10, whereby a phase difference is generated in an electromagnetic wave propagated through a waveguide path due to a periodic structure in which the height is, for example, low in the B-B cross section and high in the A-A cross section.

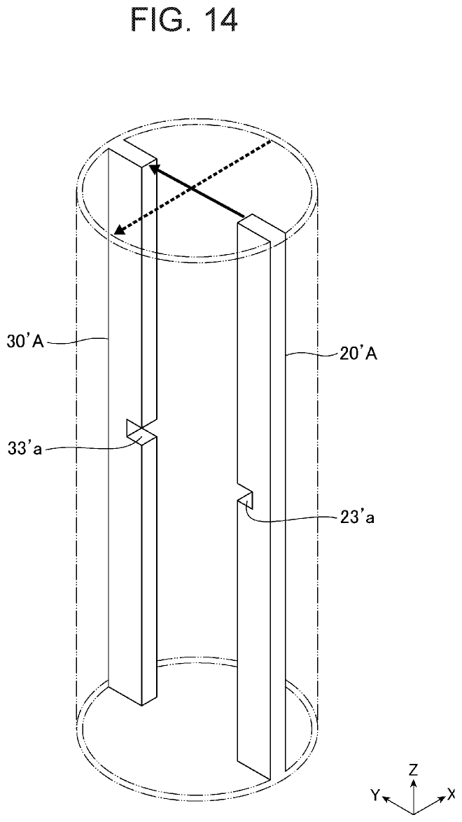

FIG. 14 illustrates a structure with one comb, in which one groove 23′a and one groove 33′a are illustrated on a pair of ridges 20′A and 30′A facing each other, respectively.

In FIG. 14, a broken line indicates a direction of an electric field of an electromagnetic wave of a horizontal linear polarization signal, and a solid line indicates a direction of an electric field of an electromagnetic wave of a vertical linear polarization signal.

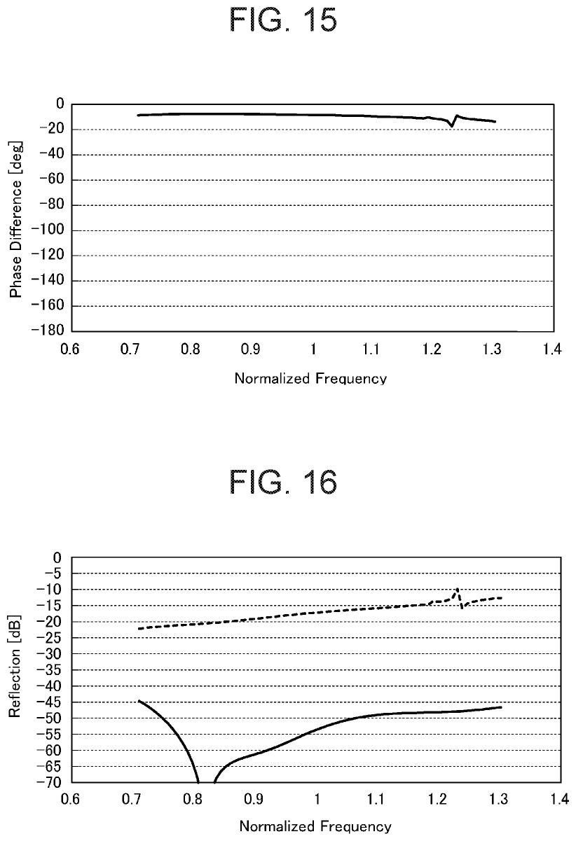

FIG. 15 illustrates a verification result for a phase characteristic that is a pass phase difference with respect to a normalized frequency obtained by electromagnetic field analysis with a structure in which the one groove 23′a and the one groove 33′a illustrated in FIG. 14 are formed on the pair of ridges 20′A and 30′A facing each other, respectively, and FIG. 16 illustrates a verification result for a reflection characteristic that is a transmission line characteristic with respect to a normalized frequency obtained by electromagnetic field analysis.

In FIG. 15, a horizontal axis represents a normalized frequency, and a vertical axis represents a phase difference.

In FIG. 16, a horizontal axis represents a normalized frequency, a vertical axis represents a reflection coefficient, a broken line represents a reflection characteristic by a horizontal linear polarization signal, and a solid line represents a reflection characteristic by a vertical linear polarization signal.

When a phase difference between two linear polarization signals orthogonal to each other due to the structure in which the one groove 23′a and the one groove 33′a are formed in the pair of ridges 20′A and 30′A, respectively, is set to about 10 deg as illustrated in FIG. 15, similarly to the phase difference between the two linear polarization signals orthogonal to each other due to the structure in which the one protrusion 23a and the one protrusion 33a are formed in the pair of ridges 20A and 30A, respectively, illustrated in FIG. 9, reflection characteristics in the two linear polarization signals orthogonal to each other exhibit largely different reflection characteristics as illustrated in FIG. 16.

As is apparent from the reflection characteristics in the structure in which the one protrusion 23a and the one protrusion 33a are formed in the pair of ridges 20A and 30A, respectively, related to the circularly polarized wave generator according to the first embodiment illustrated in FIG. 11 and the reflection characteristics in the structure in which the one groove 23′a and the one groove 33′a are formed in the pair of ridges 20′A and 30′A respectively, related to the circularly polarized wave generator according to the reference example illustrated in FIG. 16, the circularly polarized wave generator according to the first embodiment achieves a more favorable axial ratio characteristic than the circularly polarized wave generator according to the reference example.

A method for manufacturing the circularly polarized wave generator according to the first embodiment will be described.

The circularly polarized wave generator according to the first embodiment is manufactured using die molding by manufacturing integrated bodies into which the waveguide 10 and the pair of ridges 20 and 30 are bisected along the X-Z plane including the tube axis of the waveguide 10 by aluminum die casting or the like using an upper die and a lower die, and combining the bisected integrated bodies.

In addition, the circularly polarized wave generator according to the first embodiment may be manufactured using resin injection molding by forming a tube body by additive manufacturing by integrating the waveguide 10 and the pair of ridges 20 and 30, and forming a plating layer by performing metal plating on the entire inner surface of the tube body.

Furthermore, the circularly polarized wave generator according to the first embodiment may be manufactured by performing additive manufacturing by integrating the waveguide 10 and the pair of ridges 20 and 30 from the second input/output terminal 12 toward the first input/output terminal 11 by a metal 3D printer having an additive manufacturing technique.

In the case of manufacture by a metal 3D printer having an additive manufacturing technique, it is preferable to perform additive manufacturing with a manufacturing direction inclined by 45 degrees from the tube axis direction of the waveguide 10. By performing additive manufacturing with a manufacturing direction inclined by 45 degrees from the tube axis direction of the waveguide 10, collapse of protruding portions in the protruding portions 23a₁ to 23a_{N} and 33a₁ to 33a_{N} with respect to the connecting portions 23b₁ to 23b_{N-1} and 33b₁ to 33b_{N-1}, respectively, in additive manufacturing can be suppressed.

Furthermore, the circularly polarized wave generator according to the first embodiment may be manufactured by forming a tube body by additive manufacturing by integrating the waveguide 10 and the pair of ridges 20 and 30 from the second input/output terminal 12 toward the first input/output terminal 11 by a resin 3D printer having an additive manufacturing technique similarly to additive manufacturing by a metal 3D printer, and forming a plating layer by performing metal plating on the entire inner surface of the tube body.

In the circularly polarized wave generator according to the first embodiment, the pair of ridges 20 and 30 are arranged in such a manner as to face each other on the inner wall surface of the hollow waveguide 10 having a hollow portion with a circular cross section, the intermediate portions 23 and 33 in the pair of ridges 20 and 30 have the plurality of protruding portions 23a₁ to 23a_{N} and 33a₁ to 33a_{N} periodically arranged in the tube axis direction of the waveguide 10 and each protruding in a direction along a line (a line in the X direction) orthogonal to a line (a line in the Y direction) connecting central axes of the pair of ridges 20 and 30, and the connecting portions 23b₁ to 23b_{N-1} and 33b₁ to 33b_{N-1} connecting adjacent protruding portions in the plurality of protruding portions 23a₁ to 23a_{N} and 33a₁ to 33a_{N} on the first plane (X-Y plane) perpendicular to the tube axis of the waveguide 10, respectively. Therefore, the circularly polarized wave generator according to the first embodiment can obtain a favorable reflection characteristic and axial ratio characteristic.

For connection to a horn antenna having a circular waveguide terminal, a converter from a square waveguide to a circular waveguide for connection to the horn antenna is not required, which does not increase a length in a tube axis direction.

Furthermore, by forming the plurality of protruding portions 23a₁ to 23a_{N} and 33a₁ to 33a_{N} in such a manner that a length (lateral width) in a direction along a line orthogonal to a line connecting central axes of the pair of ridges 20 and 30 becomes shorter in a trigonometric function shape as it is closer to the first input/output end portions 21 and 31 and the second input/output end portions 22 and 32 with protruding portions at centers of the central axes of the ridges 20 and 30 as vertexes, the shape is gently changed, and therefore a more favorable reflection characteristic can be achieved. second embodiment.

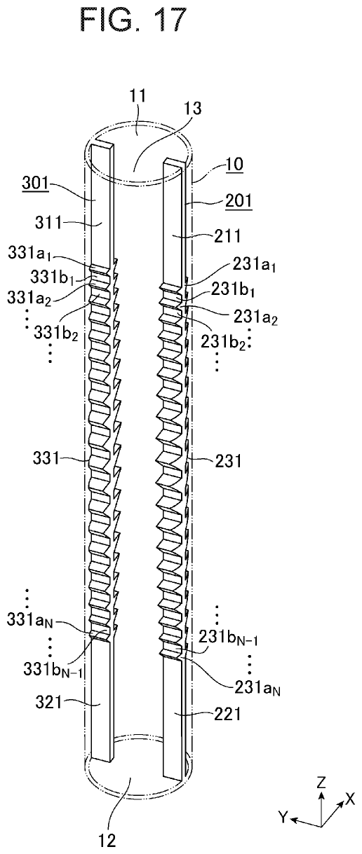

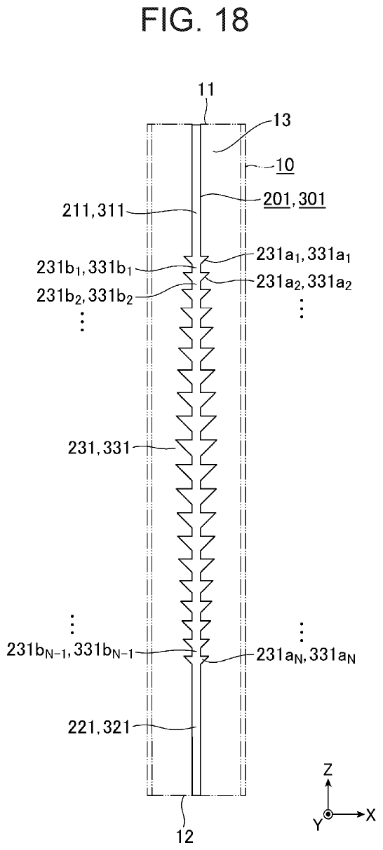

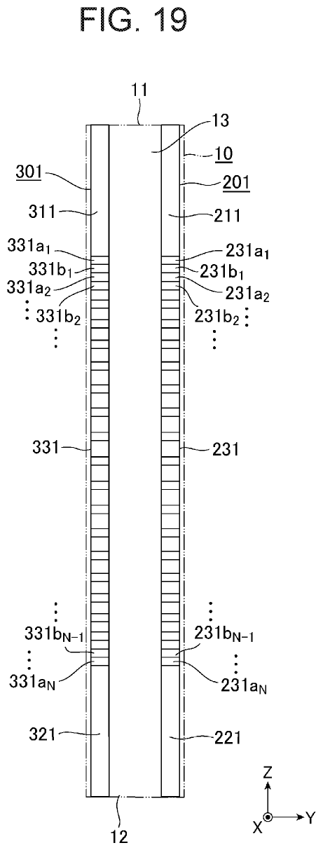

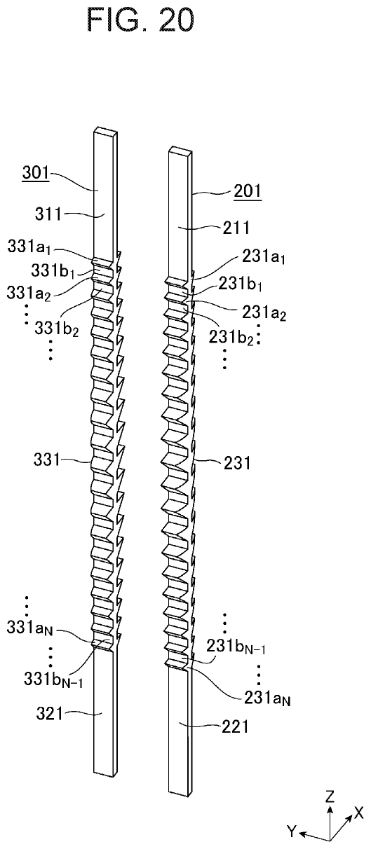

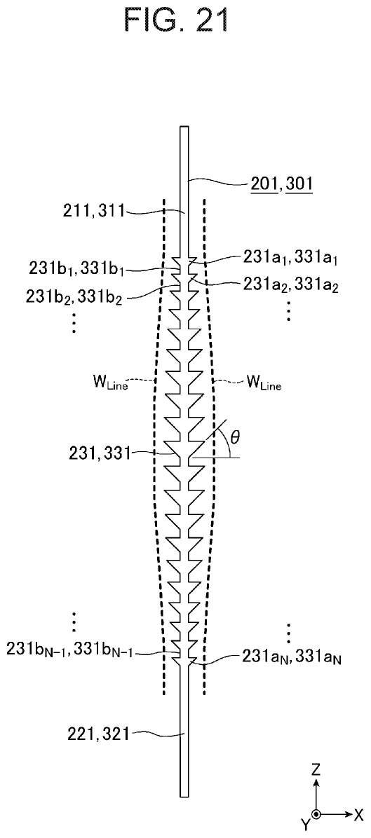

A circularly polarized wave generator according to a second embodiment will be described with reference to FIGS. 17 to 21.

The circularly polarized wave generator according to the second embodiment is different from the circularly polarized wave generator according to the first embodiment in that each of a plurality of protruding portions 231a₁ to 231a_{N} and 331a₁ to 331a_{N} in intermediate portions 231 and 331 of a pair of ridges 201 and 301 in the circularly polarized wave generator according to the second embodiment has a trapezoidal cross section parallel to the third plane which is the X-Z plane, whereas each of the plurality of protruding portions 23a₁ to 23a_{N} and 33a₁ to 33a_{N} in the intermediate portions 23 and 33 of the pair of ridges 20 and 30 in the circularly polarized wave generator according to the first embodiment has a rectangular cross section parallel to the third plane which is the X-Z plane, and the other points are the same.

In FIGS. 17 to 21, the same reference numerals as in FIGS. 1 to 5 denote the same or corresponding portions.

The circularly polarized wave generator according to the second embodiment includes a circular waveguide 10 and a pair of ridges 201 and 301.

The pair of ridges 201 and 301 each have a central axis parallel to a tube axis of the waveguide 10 and are arranged in such a manner as to face each other on an inner wall surface of the waveguide 10.

The pair of ridges 201 and 301 has a symmetrical structure with respect to a third plane passing through the tube axis of the waveguide 10.

The pair of ridges 201 and 301 is integrated with the waveguide 10.

The pair of ridges 201 and 301 have first input/output end portions 211 and 311 at a first end, second input/output end portions 221 and 321 at a second end, and intermediate portions 231 and 331 between the first input/output end portions 211 and 311 and the second input/output end portions 221 and 321, respectively.

The first input/output end portions 211 and 311 are the same as the first input/output end portions 21 and 31 in the circularly polarized wave generator according to the first embodiment, respectively.

The second input/output end portions 221 and 321 are the same as the second input/output end portions 22 and 32 in the circularly polarized wave generator according to the first embodiment, respectively.

The intermediate portions 231 and 331 have a plurality of protruding portions 231a₁ to 231a_{N} and 331a₁ to 331a_{N} periodically arranged in the tube axis direction of the waveguide 10, that is, in the Z-axis direction, and connecting portions 231b₁ to 231b_{N-1} and 331b₁ to 331b_{N-1} connecting adjacent protruding portions in the plurality of protruding portions 231a₁ to 231a_{N} and 331a₁ to 331a_{N}, respectively.

The plurality of protruding portions 231a₁ to 231a_{N} and 331a₁ to 331a_{N} protrude from the connecting portions 231b₁ to 231b_{N} and 331b₁ to 331b_{N} in a direction along a line orthogonal to a line connecting the central axes of the pair of ridges 201 and 301, that is, in the X-axis direction on the first plane perpendicular to the tube axis of the waveguide 10, that is, on the X-Y plane, respectively.

Each of the plurality of protruding portions 231a₁ to 231a_{N} and 331a₁ to 331a_{N} has a trapezoidal cross section parallel to the third plane which is the X-Z plane.

In the plurality of protruding portions 231a₁ to 231a_{N}, the trapezoid which is the shape of a cross section parallel to the third plane is an isosceles trapezoid in which the length of a lower base is the same as a lateral width W₀ of each of the connecting portions 231b₁ to 231b_{N-1}, and the length of an upper base, that is, a lateral width W is longer than the length W₀ of the lower base and sequentially becomes shorter as it goes from a protruding portion at a center of a central axis of the ridge 201 toward each of the first input/output end portion 211 and the second input/output end portion 221.

A lateral width Wₙ (n is 1 to N, corresponding to the length W of the upper base) in the plurality of protruding portions 231a₁ to 231a_{N} has the following relationship in the second embodiment as in the first embodiment.

W₁<W₂<. . . <W_{(N-2)/2}<W_{N/2}>W_{(N+2)/2}>. . . >W_{N-1}>W_{N}

As indicated by a broken line W_{Line} in FIG. 21, the relationship of the lateral width Wₙ in the plurality of protruding portions 231a₁ to 231a_{N} preferably becomes shorter in a trigonometric function shape as it is closer to the first input/output end portion 211 and the second input/output end portion 221 with the protruding portion 231a_{N/2} at the center as a vertex.

In the plurality of protruding portions 231a₁ to 231a_{N}, an angle between the lower base and a leg is θ as illustrated in FIG. 21. θ is preferably 45 degrees or more and less than 90 degrees. In the second embodiment, θ is 45 degrees.

In the plurality of protruding portions 231a₁ to 231a_{N}, a length in the Z-axis direction, that is a longitudinal width L becomes sequentially shorter as it goes from the protruding portion 231a_{N/2} at the center of the central axis of the ridge 201 toward each of the first input/output end portion 211 and the second input/output end portion 221.

A longitudinal width Lₙ in the plurality of protruding portions 231a₁ to 231a_{N} has the following relationship in the second embodiment as in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

The plurality of protruding portions 231a₁ to 231a_{N} have the same height H.

A boundary surface between each of the plurality of protruding portions 231a₁ to 231a_{N} and an inner wall surface of the waveguide 10 is an arc surface along the inner wall surface of the waveguide 10 with respect to the X-Z plane.

A facing surface facing the boundary surface in each of the plurality of protruding portions 231a₁ to 231a_{N} is an isosceles trapezoid and is a plane parallel to the X-Z plane.

In the ridge 201, the facing surface in each of the plurality of protruding portions 231a₁ to 231a_{N} are on the same X-Z plane as the facing surface in the first input/output end portion 211 and the facing surface in the second input/output end portion 221.

In the plurality of protruding portions 331a₁ to 331a_{N}, the trapezoid which is the shape of a cross section parallel to the third plane is an isosceles trapezoid in which the length of a lower base is the same as a lateral width W₀ of each of the connecting portions 331b₁ to 331b_{N-1}, and the length of an upper base, that is, a width W is longer than the length W₀ of the lower base and sequentially becomes shorter as it goes from a protruding portion at a center of a central axis of the ridge 301 toward each of the first input/output end portion 311 and the second input/output end portion 321.

A lateral width Wₙ (n is 1 to N, corresponding to the length W of the upper base) in the plurality of protruding portions 331a₁ to 331a_{N} has the following relationship in the second embodiment as in the first embodiment.

W₁<W₂<. . . <W_{(N-2)/2}<W_{N/2}>W_{(N+2)/2}>. . . >W_{N-1}>W_{N}

As indicated by a broken line W_{Line} in FIG. 21, the relationship of the lateral width Wₙ in the plurality of protruding portions 331a₁ to 331a_{N} preferably becomes shorter in a trigonometric function shape as it is closer to the first input/output end portion 311 and the second input/output end portion 321 with the protruding portion 331a_{N/2} at the center as a vertex.

In the plurality of protruding portions 331a₁ to 331a_{N}, an angle between the lower base and a leg is θ as illustrated in FIG. 21. θ is preferably 45 degrees or more and less than 90 degrees. In the second embodiment, θ is 45 degrees.

In the plurality of protruding portions 331a₁ to 331a_{N}, a length in the Z-axis direction, that is a longitudinal width L becomes sequentially shorter as it goes from the protruding portion 331a_{N/2} at the center of the central axis of the ridge 301 toward each of the first input/output end portion 311 and the second input/output end portion 321.

A longitudinal width Lₙ in the plurality of protruding portions 331a₁ to 331a_{N} has the following relationship in the second embodiment as in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

The plurality of protruding portions 331a₁ to 331a_{N} have the same height H.

A boundary surface between the plurality of protruding portions 331a₁ to 331a_{N} and an inner wall surface of the waveguide 10 is an arc surface along the inner wall surface of the waveguide 10 with respect to the X-Z plane.

A facing surface facing the boundary surface in the plurality of protruding portions 331a₁ to 331a_{N} is an isosceles trapezoid and is a plane parallel to the X-Z plane.

In the ridge 301, the facing surface in the plurality of protruding portions 331a₁ to 331a_{N} is on the same X-Z plane as the facing surface in the first input/output end portion 311 and the facing surface in the second input/output end portion 321.

Each of the connecting portions 231b₁ to 231b_{N-1} and 331b₁ to 331b_{N-1} has a rectangular cross section parallel to the third plane which is the X-Z plane.

The connecting portions 231b₁ to 231b_{N-1} have the same lateral width W₀.

The connecting portions 231b₁ to 231b_{N-1} have the same longitudinal width L₀ and arrange the protruding portions 231a₁ to 231a_{N} at equal intervals.

A boundary surface between each of the connecting portions 231b₁ to 231b_{N-1} and an inner wall surface of the waveguide 10 is an arc surface along the inner wall surface of the waveguide 10 with respect to the X-Z plane.

A facing surface facing the boundary surface in each of the connecting portions 231b₁ to 231b_{N-1} is rectangular and is a plane parallel to the X-Z plane.

In the ridge 201, the facing surface in each of the connecting portions 231b₁ to 231b_{N-1} is on the same X-Z plane as the facing surface in the first input/output end portion 211 and the facing surface in the second input/output end portion 221 and the facing surfaces in the plurality of protruding portions 231a₁ to 231a_{N}.

That is, the facing surface facing the arc surface along the inner wall surface of the waveguide 10 in the ridge 201 is a plane on the X-Z plane.

The connecting portions 331b₁ to 331b_{N-1} have the same lateral width W₀.

The connecting portions 331b₁ to 331b_{N-1} have the same longitudinal width L₀ and arrange the protruding portions 331a₁ to 331a_{N} at equal intervals.

A boundary surface between each of the connecting portions 331b₁ to 331b_{N-1} and an inner wall surface of the waveguide 10 is an arc surface along the inner wall surface of the waveguide 10 with respect to the X-Z plane.

A facing surface facing the boundary surface in each of the connecting portions 331b₁ to 331b_{N-1} is rectangular and is a plane parallel to the X-Z plane.

In the ridge 301, the facing surface in each of the connecting portions 331b₁ to 331b_{N-1} is on the same X-Z plane as the facing surface in the first input/output end portion 311 and the facing surface in the second input/output end portion 321 and the facing surfaces in the plurality of protruding portions 331a₁ to 331a_{N}.

That is, the facing surface facing the arc surface along the inner wall surface of the waveguide 10 in the ridge 301 is a plane on the X-Z plane.

The facing surface in the ridge 201 and the facing surface in the ridge 301 face each other.

Since the ridges 201 and 301 in the circularly polarized wave generator according to the second embodiment have a periodic structure in which the protruding portions 231a₁ to 231a_{N} and 331a₁ to 331a_{N} having different upper base lengths, that is, different lateral widths are periodically arranged, respectively, a desired phase difference is obtained in a desired frequency band by appropriately selecting the lateral widths W of the protruding portions 231a₁ to 231a_{N} and 331a₁ to 331a_{N}, and a desired axial ratio characteristic can be achieved.

As a result, in the circularly polarized wave generator according to the second embodiment, by appropriately designing the shapes of the plurality of protruding portions 231a₁ to 231a_{N} and 331a₁ to 331a_{N} in the ridges 201 and 301, particularly the lateral width W, a desired phase difference is obtained in selected frequency bands mainly in a VHF band, a UHF band, a microwave band, and a millimeter wave band, and a circularly polarized wave signal in which a desired axial ratio characteristic is achieved is obtained.

A method for manufacturing the circularly polarized wave generator according to the second embodiment will be described.

The circularly polarized wave generator according to the second embodiment is manufactured by performing additive manufacturing by integrating the waveguide 10 and the pair of ridges 201 and 301 from the second input/output terminal 12 toward the first input/output terminal 11 along the tube axis of the waveguide 10 by a metal 3D printer having an additive manufacturing technique.

In the plurality of protruding portions 231a₁ to 231a_{N} and 331a₁ to 331a_{N} in the pair of ridges 201 and 301 in the circularly polarized wave generator according to the second embodiment, a cross section parallel to the third plane which is the X-Z plane is an isosceles trapezoid, respectively, the length of the lower base is the same as the lateral width W₀ of each of the connecting portions 231b₁ to 231b_{N-1} and 331b₁ to 331b_{N-1}, and the angle between the lower base and a leg is set to θ (45≤θ<90), and therefore a flat ceiling is not present in protruding portions in the protruding portions 23a₁ to 23a_{N} and 33a₁ to 33a_{N} with respect to the connecting portions 23b₁ to 23b_{N-1} and 33b₁ to 33b_{N-1}, respectively.

Therefore, even if additive manufacturing is sequentially performed in the tube axis direction of the waveguide 10 while metal powder is laid layer by layer and solidified by a metal 3D printer, the metal powder is laminated in the tube axis direction of the waveguide 10 with the angle θ on a side face formed by the upper base and the lower base. Therefore, protruding portions in the protruding portions 231a₁ to 231a_{N} and 331a₁ to 331a_{N} with respect to the connecting portions 231b₁ to 231b_{N-1} and 331b₁ to 331b_{N-1} do not collapse, respectively, and manufacturing accuracy is further improved without impairing accuracy of the perfect circle of the waveguide 10.

Note that, similarly to the manufacture by additive manufacturing with a metal 3D printer, the circularly polarized wave generator according to the second embodiment may be manufactured by forming a tube body by additive manufacturing by integrating the waveguide 10 and the pair of ridges 201 and 301 from the second input/output terminal 12 toward the first input/output terminal 11 along the tube axis of the waveguide 10 by a resin 3D printer, and forming a plating layer by performing metal plating on the entire inner surface of the tube body.

Similarly to the manufacture of the circularly polarized wave generator according to the first embodiment, the circularly polarized wave generator according to the second embodiment may be manufactured using die molding by manufacturing integrated bodies into which the waveguide 10 and the pair of ridges 201 and 301 are bisected by aluminum die casting or the like using an upper die and a lower die, and combining the bisected integrated bodies.

Furthermore, the circularly polarized wave generator according to the second embodiment may be manufactured using resin injection molding by forming a tube body by additive manufacturing by integrating the waveguide 10 and the pair of ridges 201 and 301, and forming a plating layer by performing metal plating on the entire inner surface of the tube body.

The circularly polarized wave generator according to the second embodiment has an effect similar to the circularly polarized wave generator according to the first embodiment.

Furthermore, the circularly polarized wave generator according to the second embodiment can be sequentially formed by additive manufacturing with high manufacturing accuracy in the tube axis direction of the waveguide 10 by a 3D printer having an additive manufacturing technique without collapsing the protruding portions 231a₁ to 231a_{N} and 331a₁ to 331a_{N} in the ridges 201 and 301.

### Third Embodiment

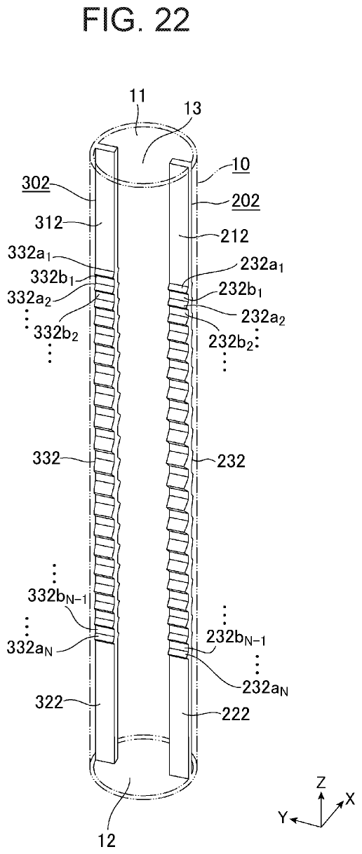

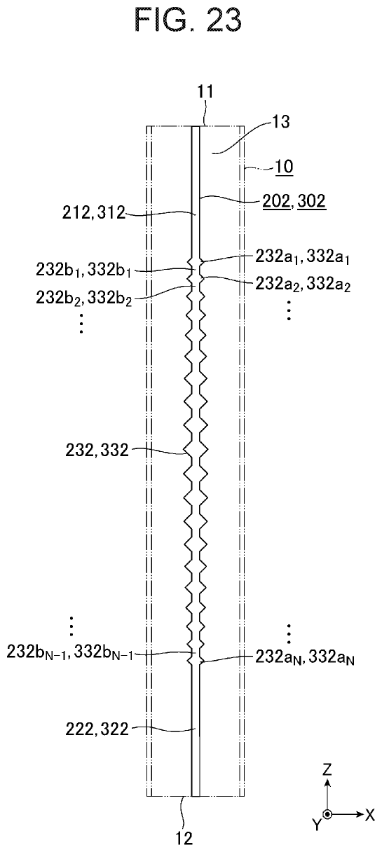

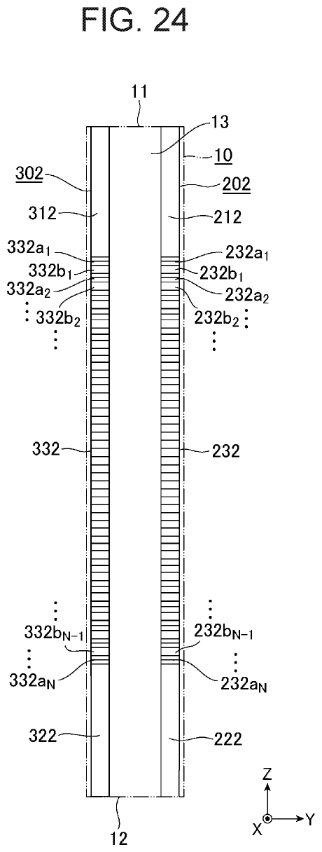

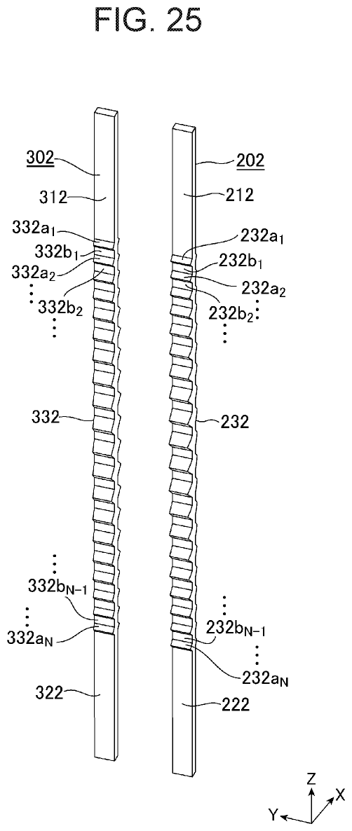

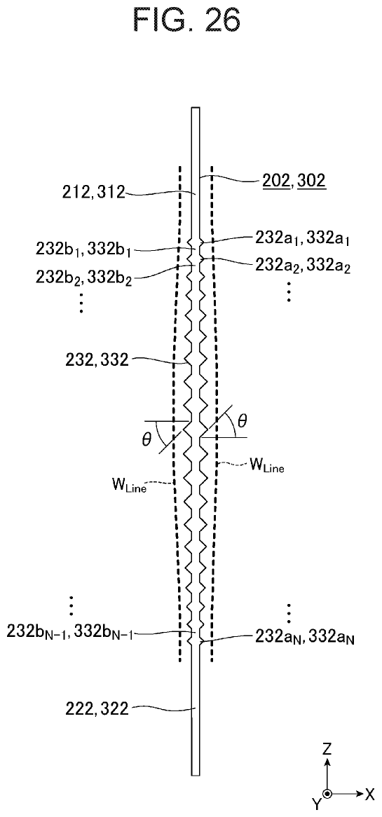

A circularly polarized wave generator according to a third embodiment will be described with reference to FIGS. 22 to 26.

The circularly polarized wave generator according to the third embodiment is different from the circularly polarized wave generator according to the first embodiment in that each of a plurality of protruding portions 232a₁ to 232a_{N} and 332a₁ to 332a_{N} in intermediate portions 232 and 332 of a pair of ridges 202 and 302 in the circularly polarized wave generator according to the third embodiment has a hexagonal cross section parallel to the third plane which is the X-Z plane, whereas each of the plurality of protruding portions 23a₁ to 23a_{N} and 33a₁ to 33a_{N} in the intermediate portions 23 and 33 of the pair of ridges 20 and 30 in the circularly polarized wave generator according to the first embodiment has a rectangular cross section parallel to the third plane which is the X-Z plane, and the other points are the same.

In FIGS. 22 to 26, the same reference numerals as in FIGS. 1 to 5 denote the same or corresponding portions.

The circularly polarized wave generator according to the third embodiment includes a circular waveguide 10 and a pair of ridges 202 and 302.

The pair of ridges 202 and 302 each have a central axis parallel to a tube axis of the waveguide 10 and are arranged in such a manner as to face each other on an inner wall surface of the waveguide 10.

The pair of ridges 202 and 302 has a symmetrical structure with respect to a third plane passing through the tube axis of the waveguide 10.

The pair of ridges 202 and 302 is integrated with the waveguide 10.

The pair of ridges 202 and 302 have first input/output end portions 212 and 312 at a first end, second input/output end portions 222 and 322 at a second end, and intermediate portions 232 and 332 between the first input/output end portions 212 and 312 and the second input/output end portions 222 and 322, respectively.

The first input/output end portions 212 and 312 are the same as the first input/output end portions 21 and 31 in the circularly polarized wave generator according to the first embodiment, respectively.

The second input/output end portions 222 and 322 are the same as the second input/output end portions 22 and 32 in the circularly polarized wave generator according to the first embodiment, respectively.

The intermediate portions 232 and 332 have a plurality of protruding portions 232a₁ to 232a_{N} and 332a₁ to 332a_{N} periodically arranged in the tube axis direction of the waveguide 10, that is, in the Z-axis direction, and connecting portions 232b₁ to 232b_{N-1} and 332b₁ to 332b_{N-1} connecting adjacent protruding portions in the plurality of protruding portions 232a₁ to 232a_{N} and 332a₁ to 332a_{N}, respectively.

The plurality of protruding portions 232a₁ to 232a_{N} and 332a₁ to 332a_{N} protrude from the connecting portions 232b₁ to 232b_{N} and 332b₁ to 332b_{N} in a direction along a line orthogonal to a line connecting the central axes of the pair of ridges 202 and 302, that is, in the X-axis direction on the first plane perpendicular to the tube axis of the waveguide 10, that is, on the X-Y plane, respectively.

Each of the plurality of protruding portions 232a₁ to 232a_{N} and 332a₁ to 332a_{N} has a hexagonal cross section parallel to the third plane which is the X-Z plane.

In the plurality of protruding portions 232a₁ to 232a_{N}, the hexagon which is the shape of a cross section parallel to the third plane has a pair of opposite sides having the same length as a lateral width W₀ of each of the connecting portions 232b₁ to 232b_{N-1}, and is bilaterally symmetrical with respect to a Y-Z plane passing through a central axis of the ridge 202.

The plurality of protruding portions 232a₁ to 232a_{N} are vertically symmetrical with respect to an X-Y plane passing through a line connecting left and right vertexes of the hexagon.

In the plurality of protruding portions 232a₁ to 232a_{N}, a length connecting the left and right vertexes of the hexagon, that is, a lateral width W is longer than the length W₀ of the opposite side, and becomes sequentially shorter as it goes from a protruding portion at a center of a central axis of the ridge 202 toward each of the first input/output end portion 212 and the second input/output end portion 222.

A lateral width Wₙ (n is 1 to N) in the plurality of protruding portions 232a₁ to 232a_{N} has the following relationship in the third embodiment as in the first embodiment.

W₁<W₂<. . . <W_{(N-2)/2}<W_{N/2}>W_{(N+2)/2}>. . . >W_{N-1}>W_{N}

As indicated by a broken line W_{Line} in FIG. 26, the relationship of the lateral width Wₙ in the plurality of protruding portions 232a₁ to 232a_{N} preferably becomes shorter in a trigonometric function shape as it is closer to the first input/output end portion 212 and the second input/output end portion 222 with the protruding portion 232a_{N/2} at the center as a vertex.

In the plurality of protruding portions 232a₁ to 232a_{N}, an angle between an opposite side and an oblique side on both sides in the central axis direction of the ridge 202 is θ as illustrated in FIG. 26. θ is preferably 45 degrees or more and less than 90 degrees. Assuming that a cross section parallel to the X-Z plane in each of the protruding portions 232a₁ to 232a is a regular hexagon, θ is 60 degrees.

In the plurality of protruding portions 232a₁ to 232a_{N}, a length in the Z-axis direction, that is a longitudinal width L becomes sequentially shorter as it goes from the protruding portion 232a_{N/2} at the center of the central axis of the ridge 202 toward each of the first input/output end portion 212 and the second input/output end portion 222.

A longitudinal width Lₙ in the plurality of protruding portions 232a₁ to 232a_{N} has the following relationship in the third embodiment as in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

The plurality of protruding portions 232a₁ to 232a_{N} have the same height H.

A boundary surface between each of the plurality of protruding portions 232a₁ to 232a_{N} and an inner wall surface of the waveguide 10 is an arc surface along the inner wall surface of the waveguide 10 with respect to the X-Z plane.

A facing surface facing the boundary surface in each of the plurality of protruding portions 232a₁ to 232a_{N} is hexagonal and is a plane parallel to the X-Z plane.

In the ridge 202, the facing surfaces in the plurality of protruding portions 232a₁ to 232a_{N} are on the same X-Z plane as the facing surface in the first input/output end portion 212 and the facing surface in the second input/output end portion 222.

In the plurality of protruding portions 332a₁ to 332a_{N}, the hexagon which is the shape of a cross section parallel to the third plane has a pair of opposite sides having the same length as a lateral width W₀ of each of the connecting portions 232b₁ to 232b_{N-1}, and is bilaterally symmetrical with respect to a Y-Z plane passing through a central axis of the ridge 302.

The plurality of protruding portions 332a₁ to 332a_{N} are vertically symmetrical with respect to an X-Y plane passing through a line connecting left and right vertexes of the hexagon.

In the plurality of protruding portions 332a₁ to 332a_{N}, a length connecting the left and right vertexes of the hexagon, that is, a lateral width W is longer than the length W₀ of the opposite side, and becomes sequentially shorter as it goes from a protruding portion at a center of a central axis of the ridge 302 toward each of the first input/output end portion 312 and the second input/output end portion 322.

A lateral width Wₙ (n is 1 to N) in the plurality of protruding portions 332a₁ to 332a_{N} has the following relationship in the third embodiment as in the first embodiment.

W₁<W₂<. . . <W_{(N-2)/2}<W_{N/2}>W_{(N+2)/2}>. . . >W_{N-1}>W_{N}

As indicated by a broken line W_{Line} in FIG. 26, the relationship of the lateral width Wₙ in the plurality of protruding portions 332a₁ to 332a_{N} preferably becomes shorter in a trigonometric function shape as it is closer to the first input/output end portion 312 and the second input/output end portion 322 with the protruding portion 332a_{N/2} at the center as a vertex.

In each of the plurality of protruding portions 332a₁ to 332a_{N}, an angle between an opposite side and an oblique side on both sides in the central axis direction of the ridge 302 is θ as illustrated in FIG. 26. θ is preferably 45 degrees or more and less than 90 degrees. Assuming that a cross section parallel to the X-Z plane in each of the protruding portions 332a₁ to 332a_{N} is a regular hexagon, θ is 60 degrees.

In the plurality of protruding portions 332a₁ to 332a_{N}, a length in the Z-axis direction, that is a longitudinal width L becomes sequentially shorter as it goes from the protruding portion 332a_{N/2} at the center of the central axis of the ridge 302 toward each of the first input/output end portion 312 and the second input/output end portion 322.

A longitudinal width Lₙ in the plurality of protruding portions 332a₁ to 332a_{N} has the following relationship in the third embodiment as in the first embodiment.

L₁<L₂<. . . <L_{(N-2)/2}<L_{N/2}>L_{(N+2)/2}>. . . >L_{N-1}>L_{N}

Note that all the longitudinal widths Lₙ may be the same.

The plurality of protruding portions 332a₁ to 332a_{N} have the same height H.

A boundary surface between each of the plurality of protruding portions 332a₁ to 332a_{N} and an inner wall surface of the waveguide 10 is an arc surface along the inner wall surface of the waveguide 10 with respect to the X-Z plane.

A facing surface facing the boundary surface in each of the plurality of protruding portions 332a₁ to 332a_{N} is hexagonal and is a plane parallel to the X-Z plane.

In the ridge 302, the facing surfaces in the plurality of protruding portions 332a₁ to 332a_{N} are on the same X-Z plane as the facing surface in the first input/output end portion 312 and the facing surface in the second input/output end portion 322.

Each of the connecting portions 232b₁ to 232b_{N-1} and 332b₁ to 332b_{N-1} has a rectangular cross section parallel to the third plane which is the X-Z plane.

The connecting portions 232b₁ to 232b_{N-1} have the same lateral width W₀.

The connecting portions 232b₁ to 232b_{N-1} have the same longitudinal width L₀ and arrange the protruding portions 232a₁ to 232a_{N} at equal intervals.

A boundary surface between each of the connecting portions 232b₁ to 232b_{N-1} and an inner wall surface of the waveguide 10 is an arc surface along the inner wall surface of the waveguide 10 with respect to the X-Z plane.

A facing surface facing the boundary surface in each of the connecting portions 232b₁ to 232b_{N-1} is rectangular and is a plane parallel to the X-Z plane.

In the ridge 202, the facing surface in each of the connecting portions 232b₁ to 232b_{N-1} is on the same X-Z plane as the facing surface in the first input/output end portion 212 and the facing surface in the second input/output end portion 222 and the facing surfaces in the plurality of protruding portions 232a₁ to 232a_{N}.

That is, the facing surface facing the arc surface along the inner wall surface of the waveguide 10 in the ridge 202 is a plane on the X-Z plane.

The ridge 202 is vertically symmetrical with respect to an X-Y plane passing through a line connecting left and right vertexes of the hexagon in the protruding portion 232a_{N/2} at a center.

The connecting portions 332b₁ to 332b_{N-1} have the same lateral width W₀.

The connecting portions 332b₁ to 332b_{N-1} have the same longitudinal width L₀ and arrange the protruding portions 332a₁ to 332a_{N} at equal intervals.

A boundary surface between each of the connecting portions 332b₁ to 332b_{N-1} and an inner wall surface of the waveguide 10 is an arc surface along the inner wall surface of the waveguide 10 with respect to the X-Z plane.

A facing surface facing the boundary surface in each of the connecting portions 332b₁ to 332b_{N-1} is rectangular and is a plane parallel to the X-Z plane.

In the ridge 302, the facing surface in each of the connecting portions 332b₁ to 332b_{N-1} is on the same X-Z plane as the facing surface in the first input/output end portion 312 and the facing surface in the second input/output end portion 322 and the facing surfaces in the plurality of protruding portions 332a₁ to 332a_{N}.

That is, the facing surface facing the arc surface along the inner wall surface of the waveguide 10 in the ridge 302 is a plane on the X-Z plane.

The ridge 302 is vertically symmetrical with respect to an X-Y plane passing through a line connecting left and right vertexes of the hexagon in the protruding portion 332a_{N/2} at a center.

The facing surface in the ridge 202 and the facing surface in the ridge 302 face each other.

Since the ridges 202 and 302 in the circularly polarized wave generator according to the third embodiment have a periodic structure in which the protruding portions 232a₁ to 232a_{N} and 332a₁ to 332a_{N} having different lengths of a line connecting left and right vertexes of the hexagon, that is, different lateral widths are periodically arranged, respectively, a desired phase difference is obtained in a desired frequency band by appropriately selecting the lateral widths W of the protruding portions 232a₁ to 232a_{N} and 332a₁ to 332a_{N}, and a desired axial ratio characteristic can be achieved.

As a result, in the circularly polarized wave generator according to the third embodiment, by appropriately designing the shapes of the plurality of protruding portions 232a₁ to 232a_{N} and 332a₁ to 332a_{N} in the ridges 202 and 302, particularly the lateral width W, a desired phase difference is obtained in selected frequency bands mainly in a VHF band, a UHF band, a microwave band, and a millimeter wave band, and a circularly polarized wave signal in which a desired axial ratio characteristic is achieved is obtained.

Similarly to the circularly polarized wave generator according to the second embodiment, the circularly polarized wave generator according to the third embodiment is also manufactured by performing additive manufacturing by integrating the waveguide 10 and the pair of ridges 202 and 302 from the second input/output terminal 12 toward the first input/output terminal 11 along the tube axis of the waveguide 10 by a metal 3D printer having an additive manufacturing technique.

In the plurality of protruding portions 232a₁ to 232a_{N} and 332a₁ to 332a_{N} in the pair of ridges 202 and 302 in the circularly polarized wave generator according to the third embodiment, a cross section parallel to the third plane which is the X-Z plane is a hexagon, respectively, the length of the pair of opposite sides is the same as the lateral width W₀ of each of the connecting portions 232b₁ to 232b_{N-1} and 332b₁ to 332b_{N-1}, and the angle between the opposite side and the oblique side is set to θ (45≤θ<90), and therefore a flat ceiling is not present in protruding portions in the protruding portions 231a₁ to 231a_{N} and 331a₁ to 331a_{N} with respect to the connecting portions 231b₁ to 231b_{N-1} and 331b₁ to 331b_{N-1}, respectively.

Therefore, even additive manufacturing is sequentially performed in the tube axis direction of the waveguide 10 while metal powder is laid layer by layer and solidified by a metal 3D printer, the metal powder is laminated in the tube axis direction of the waveguide 10 with the angle θ on a side face formed by the lower opposite side and the lower oblique side. Therefore, protruding portions in the protruding portions 231a₁ to 231a_{N} and 331a₁ to 331a_{N} with respect to the connecting portions 231b₁ to 231b_{N-1} and 331b₁ to 331b_{N-1} do not collapse, respectively, and manufacturing accuracy is further improved without impairing accuracy of the perfect circle of the waveguide 10.

Note that, similarly to the manufacture by additive manufacturing by a resin 3D printer, the circularly polarized wave generator according to the third embodiment may be manufactured by forming a tube body by additive manufacturing by integrating the waveguide 10 and the pair of ridges 202 and 302 from the second input/output terminal 12 toward the first input/output terminal 11 along the tube axis of the waveguide 10 by a resin 3D printer, and forming a plating layer by performing metal plating on the entire inner surface of the tube body.

Similarly to the manufacture of the circularly polarized wave generator according to the first embodiment, the circularly polarized wave generator according to the third embodiment may be manufactured using die molding by manufacturing integrated bodies into which the waveguide 10 and the pair of ridges 202 and 302 are bisected by aluminum die casting or the like using an upper die and a lower die, and combining the bisected integrated bodies.

Furthermore, the circularly polarized wave generator according to the third embodiment may be manufactured using resin injection molding by forming a tube body by additive manufacturing by integrating the waveguide 10 and the pair of ridges 202 and 302, and forming a plating layer by performing metal plating on the entire inner surface of the tube body.

The circularly polarized wave generator according to the third embodiment has an effect similar to the circularly polarized wave generator according to the first embodiment.

In addition, in the ridges 202 and 302, the ridges 202 and 302 are vertically symmetrical with respect to the X-Y plane passing through a line connecting the left and right vertexes of the hexagon in the protruding portions 232a_{N/2} and 332a_{N/2} at centers, respectively, therefore symmetry in the tube axis direction is improved, and a more favorable reflection characteristic and a more favorable axial ratio characteristic can be achieved.

Furthermore, the circularly polarized wave generator according to the third embodiment can be sequentially formed by additive manufacturing with high manufacturing accuracy in the tube axis direction of the waveguide 10 by a 3D printer having an additive manufacturing technique without collapsing the protruding portions 231a₁ to 231a_{N} and 331a₁ to 331a_{N} in the ridges 202 and 302.

### Fourth Embodiment

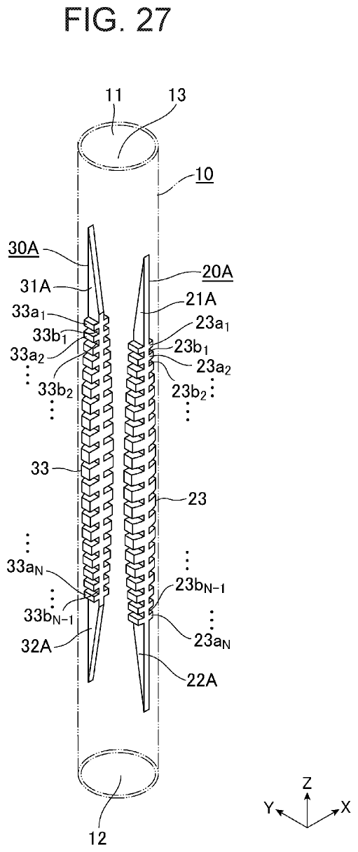

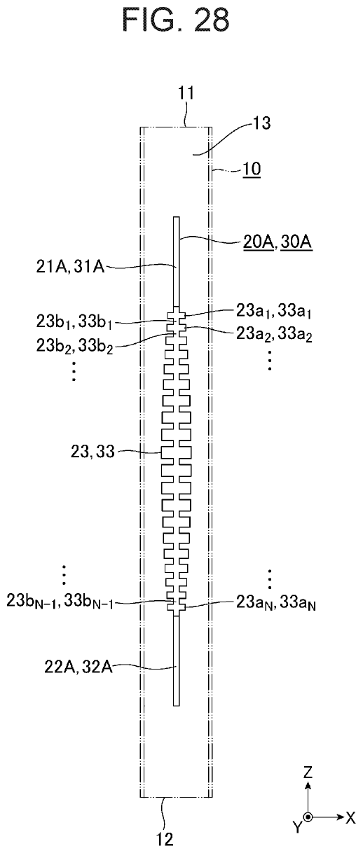

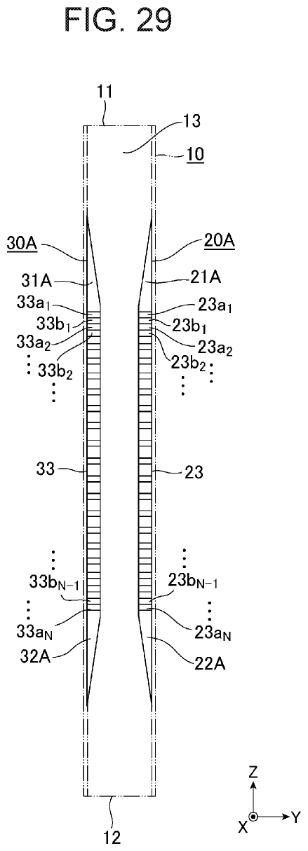

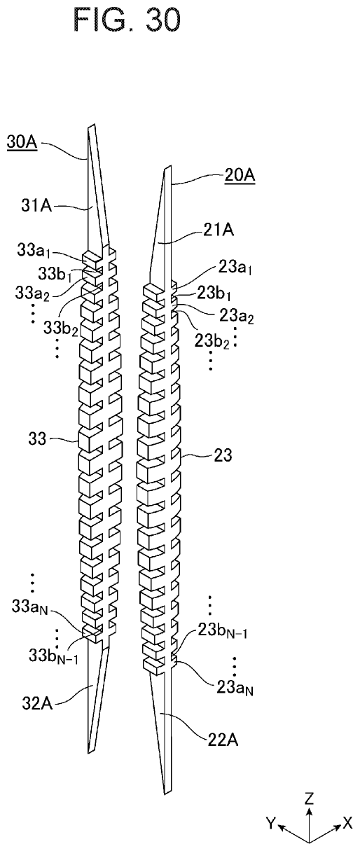

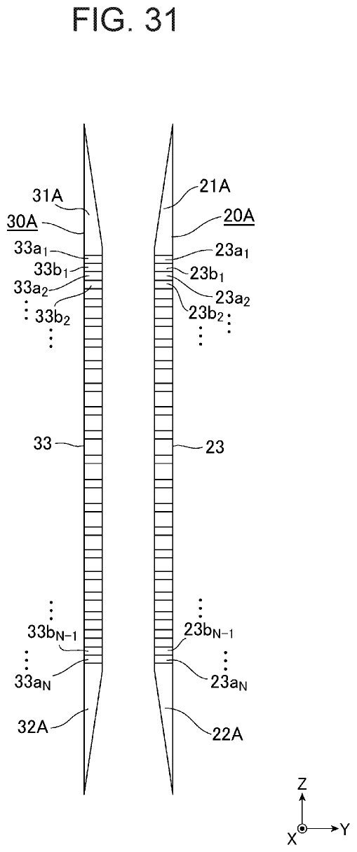

A circularly polarized wave generator according to a fourth embodiment will be described with reference to FIGS. 27 to 31.

The lengths of the first input/output end portions 21 and 31 and the second input/output end portions 22 and 32 in the pair of ridges 20 and 30 in the circularly polarized wave generator according to the first embodiment in a direction along a line connecting the central axes of the pair of ridges 20 and 30 are uniform over the entire length, and the lengths of the first input/output end portions 21 and 31 and the second input/output end portions 22 and 32 in a direction along a line orthogonal to the line connecting the central axes of the pair of ridges 20 and 30 are uniform over the entire length.

On the other hand, the circularly polarized wave generator according to the fourth embodiment is different from the circularly polarized wave generator according to the first embodiment in that first input/output end portions 21A and 31A in a pair of ridges 20A and 30A have tapered shapes having a shorter length as it is closer to the first input/output terminal 11 in a second plane including central axes of the pair of ridges 20A and 30A, respectively, and second input/output end portions 22A and 32A in the pair of ridges 20A and 30A have tapered shapes having a shorter length as it is closer to the second input/output terminal 12 in the second plane including the central axes of the pair of ridges 20A and 30A, respectively, and the other points are the same.

In FIGS. 27 to 31, the same reference numerals as in FIGS. 1 to 5 denote the same or corresponding portions.

Therefore, hereinafter, the pair of ridges 20A and 30A, particularly the first input/output end portions 21A and 31A and the second input/output end portions 22A and 32A, which are different points, will be mainly described.

The circularly polarized wave generator according to the fourth embodiment includes a circular waveguide 10 and the pair of ridges 20A and 30A, and has an integrated configuration.

The circular waveguide 10 is the same as the circular waveguide 10 in the circularly polarized wave generator according to the first embodiment, and thus description thereof is omitted.

The pair of ridges 20A and 30A have first input/output end portions 21A and 31A at a first end, second input/output end portions 22A and 32A at a second end, and intermediate portions 23 and 33 between the first input/output end portions 21A and 31A and the second input/output end portions 22A and 32A, respectively.

The intermediate portions 23 and 33 are the same as the intermediate portions 23 and 33 in the circularly polarized wave generator according to the first embodiment, respectively, and thus description thereof is omitted.

The heights (lengths in the Y-axis direction) of the first input/output end portions 21A and 31A become gradually shorter as they go from the protruding portions 23a₁ and 33a₁ of the intermediate portions 23 and 33 toward the first input/output terminal 11, respectively.

The heights of the first input/output end portions 21A and 31A preferably become shorter in a trigonometric function shape, but may become shorter linearly.

The lateral widths (lengths in the X-axis direction) of the first input/output end portions 21A and 31A are uniform over the entire length in the Z-axis direction, and are the same as the lateral width W₀ of the connecting portions 23b₁ to 23b_{N-1} and 33b₁ to 33b_{N-1} of the intermediate portions 23 and 33.

A boundary surface between each of the first input/output end portions 21A and 31A and an inner wall surface of the waveguide 10 is an arc surface along the inner wall surface of the waveguide 10 with respect to the X-Z plane.

A facing surface facing the boundary surface in each of the first input/output end portions 21A and 31A is rectangular and is a plane inclined with respect to the X-Z plane.

The first input/output end portion 21A and the first input/output end portion 31A have the same size and the same shape.

The heights of the second input/output end portions 22A and 32A become gradually shorter as they go from the protruding portions 23a_{N} and 33a_{N} of the intermediate portions 23 and 33 toward the second input/output terminal 12, respectively.

The heights of the second input/output end portions 22A and 32A preferably become shorter in a trigonometric function shape, but may become shorter linearly.

The lateral widths of the second input/output end portions 22A and 32A are uniform over the entire length in the Z-axis direction, and are the same as the lateral width W₀ of the connecting portions 23b₁ to 23b_{N-1} and 33b₁ to 33b_{N-1} of the intermediate portions 23 and 33.

A boundary surface between each of the second input/output end portions 22A and 32A and an inner wall surface of the waveguide 10 is an arc surface along the inner wall surface of the waveguide 10 with respect to the X-Z plane.

A facing surface facing the boundary surface in each of the second input/output end portions 22A and 32A is rectangular and is a plane inclined with respect to the X-Z plane.

The second input/output end portion 22A and the second input/output end portion 32A have the same size and the same shape.

Similarly to the manufacturing of the circularly polarized wave generator according to the first embodiment, the circularly polarized wave generator according to the fourth embodiment is manufactured by die molding.

Note that, as described in the circularly polarized wave generator according to the first embodiment, the circularly polarized wave generator according to the fourth embodiment may be manufactured by a metal 3D printer having an additive manufacturing technique, a resin 3D printer having an additive manufacturing technique and metal plating, or resin injection molding and metal plating.

The circularly polarized wave generator according to the fourth embodiment has an effect similar to the circularly polarized wave generator according to the first embodiment, and obtains a more favorable reflection characteristic because the heights of the ridges 20A and 30A change gradually when viewed from the first input/output terminal 11 and the second input/output terminal 12.

Note that, in the circularly polarized wave generator according to the second embodiment, the first input/output end portions 211 and 311 of the ridges 201 and 301 may have shapes similar to the first input/output end portions 21A and 31A of the ridges 20A and 30A illustrated in the circularly polarized wave generator according to the fourth embodiment, respectively, and the second input/output end portions 221 and 321 of the ridges 201 and 301 may have shapes similar to the second input/output end portions 22A and 32A of the ridges 20A and 30A illustrated in the circularly polarized wave generator according to the fourth embodiment, respectively.

That is, in the circularly polarized wave generator according to the second embodiment, the heights of the first input/output end portions 211 and 311 may become gradually shorter as they go from the protruding portions 231a₁ and 331a₁ of the intermediate portions 231 and 331 toward the first input/output terminal 11, and the heights of the second input/output end portions 221 and 321 may become gradually shorter as they go from the protruding portions 231a_{N} and 331a_{N} of the intermediate portions 231 and 331 toward the second input/output terminal 12.

In the circularly polarized wave generator according to the second embodiment, the circularly polarized wave generator changed to the first input/output end portions 21A and 31A and the second input/output end portions 22A and 32A illustrated in the circularly polarized wave generator according to the fourth embodiment is manufactured by a metal 3D printer having an additive manufacturing technique similarly to the manufacture of the circularly polarized wave generator according to the second embodiment, and may be manufactured by a resin 3D printer having an additive manufacturing technique and metal plating, die molding, or resin injection molding and metal plating.

In addition, in the circularly polarized wave generator according to the third embodiment, the first input/output end portions 212 and 312 of the ridges 202 and 302 may have shapes similar to the first input/output end portions 21A and 31A of the ridges 20A and 30A illustrated in the circularly polarized wave generator according to the fourth embodiment, respectively, and the second input/output end portions 222 and 322 of the ridges 202 and 302 may have shapes similar to the second input/output end portions 22A and 32A of the ridges 20A and 30A illustrated in the circularly polarized wave generator according to the fourth embodiment, respectively.

That is, in the circularly polarized wave generator according to the third embodiment, the heights of the first input/output end portions 212 and 312 may become gradually shorter as they go from the protruding portions 232a₁ and 332a₁ of the intermediate portions 232 and 332 toward the first input/output terminal 11, and the heights of the second input/output end portions 222 and 322 may become gradually shorter as they go from the protruding portions 232a_{N} and 332a_{N} of the intermediate portions 232 and 332 toward the second input/output terminal 12.

In the circularly polarized wave generator according to the third embodiment, the circularly polarized wave generator changed to the first input/output end portions 21A and 31A and the second input/output end portions 22A and 32A illustrated in the circularly polarized wave generator according to the fourth embodiment is manufactured by a metal 3D printer having an additive manufacturing technique similarly to the manufacture of the circularly polarized wave generator according to the third embodiment, and may be manufactured by a resin 3D printer having an additive manufacturing technique and metal plating, die molding, or resin injection molding and metal plating.

### Fifth Embodiment

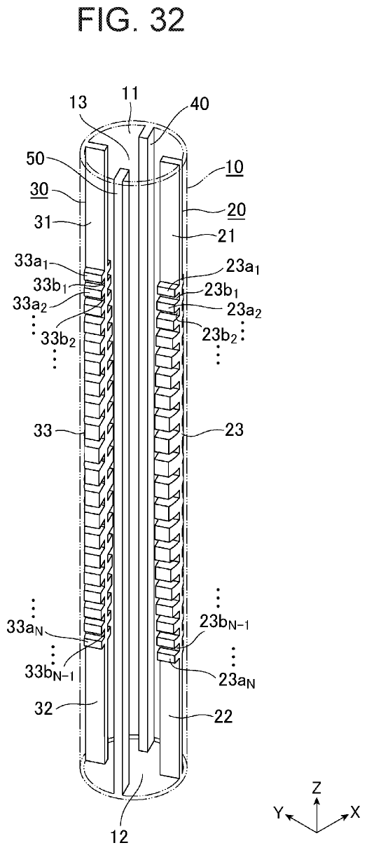

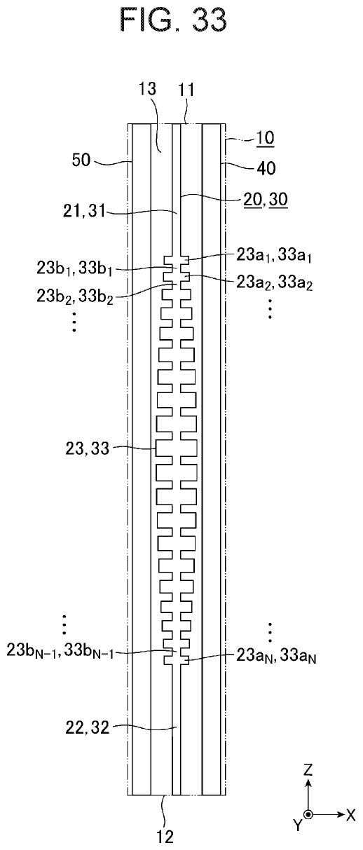

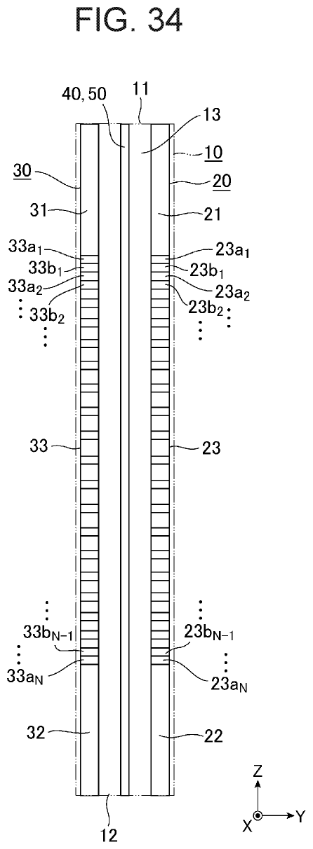

A circularly polarized wave generator according to a fifth embodiment will be described with reference to FIGS. 32 to 35.

The circularly polarized wave generator according to the fifth embodiment is different from the circularly polarized wave generator according to the first embodiment in including a pair of second ridges 40 and 50, and the other points are the same.

In FIGS. 32 to 35, the same reference numerals as in FIGS. 1 to 5 denote the same or corresponding portions.

Therefore, hereinafter, the pair of second ridges 40 and 50, which is a different point, will be mainly described.

The circularly polarized wave generator according to the fifth embodiment includes a circular waveguide 10, a pair of first ridges 20 and 30, and the pair of second ridges 40 and 50, and the waveguide 10, the pair of first ridges 20 and 30, and the pair of second ridges 40 and 50 are integrally formed.

Each of the pair of second ridges 40 and 50 has a central axis parallel to a tube axis of the waveguide 10, and the pair of second ridges 40 and 50 are arranged in such a manner as to face each other on an inner wall surface of the waveguide 10 rotated by 90 degrees about the tube axis of the waveguide 10 with respect to the pair of first ridges 20 and 30.

The pair of second ridges 40 and 50 has a symmetrical structure with respect to a second plane (Y-Z plane) passing through the tube axis which is a central axis of the waveguide 10.

The length of each of the pair of second ridges 40 and 50 in a direction along a line connecting the central axes of the pair of second ridges 40 and 50 is uniform over the entire length, and the length thereof in a direction along a line orthogonal to the line connecting the central axes of the pair of second ridges 40 and 50 is uniform over the entire length.

Hereinafter, in the second ridges 40 and 50, the length in the X-axis direction is referred to as a height, the length in the Y-axis direction is referred to as a lateral width, and the length in the Z-axis direction is referred to as a longitudinal width.

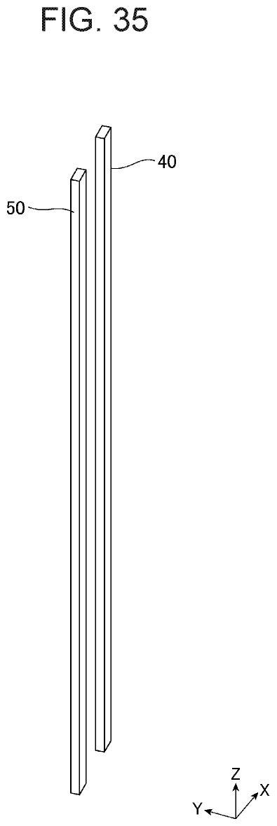

That is, in each of the second ridges 40 and 50, the lateral width is uniform over the entire length in the Z-axis direction, and the height is uniform over the entire length in the Z-axis direction as illustrated in FIG. 35.

A boundary surface between each of the second ridges 40 and 50 and an inner wall surface of the waveguide 10 is an arc surface along the inner wall surface of the waveguide 10 with respect to the Y-Z plane.

A facing surface facing the boundary surface in each of the second ridges 40 and 50 is rectangular and is a plane parallel to the Y-Z plane.

The second ridge 40 and the second ridge 50 have the same size and the same shape.

A lateral width of each of the second ridges 40 and 50 is preferably the same as lateral widths of the first input/output end portions 21 and 31 and lateral widths of the second input/output end portions 22 and 32 in terms of design parameters, but may be different.

A height of each of the second ridges 40 and 50 is preferably the same as heights of the first input/output end portions 21 and 31 and heights of the second input/output end portions 22 and 32 in terms of design parameters, but may be different.

By making the lateral width and height of each of the second ridges 40 and 50 different from those of the first input/output end portions 21 and 31 and the second input/output end portions 22 and 32, the number of design parameters increases, or a more favorable axial ratio characteristic and a more favorable reflection characteristic can be obtained.

Similarly to the manufacture of the circularly polarized wave generator according to the first embodiment, the circularly polarized wave generator according to the fifth embodiment is manufactured by die molding.

Note that, as described in the circularly polarized wave generator according to the first embodiment, the circularly polarized wave generator according to the fifth embodiment may be manufactured by a metal 3D printer having an additive manufacturing technique, a resin 3D printer having an additive manufacturing technique and metal plating, or resin injection molding and metal plating.

The circularly polarized wave generator according to the fifth embodiment has an effect similar to the circularly polarized wave generator according to the first embodiment, has improved symmetry in a cross section parallel to an X-Y plane (first plane) in a waveguide path 13, easily sets a phase difference between two linear polarization signals orthogonal to each other to a desired value, and obtains a more favorable axial ratio characteristic.

Note that the pair of second ridges 40 and 50 in the circularly polarized wave generator according to the fifth embodiment may have the following shapes as described in the pair of ridges 20 and 30 in the circularly polarized wave generator according to the first embodiment.

That is, each of the pair of second ridges 40 and 50 has a first end portion, a second end portion, and an intermediate portion between the first end portion and the second end portion.

Similarly to the intermediate portions of the pair of ridges 20 and 30 in the circularly polarized wave generator according to the first embodiment, the intermediate portions of the pair of second ridges 40 and 50 have a plurality of protruding portions periodically arranged in the tube axis direction of the waveguide 10 and each protruding in a direction along a line connecting the central axes of the pair of first ridges 20 and 30 on the X-Y plane (first plane), and connecting portions connecting adjacent protruding portions in the plurality of protruding portions.

In addition, the pair of second ridges 40 and 50 in the circularly polarized wave generator according to the fifth embodiment may have the following shapes as described in the pair of ridges 20A and 30A in the circularly polarized wave generator according to the fourth embodiment.

That is, each of the pair of second ridges 40 and 50 has a first end portion, a second end portion, and an intermediate portion between the first end portion and the second end portion.

Similarly to the first input/output end portions 21A and 31A of the pair of ridges 20A and 30A in the circularly polarized wave generator according to the fourth embodiment, a first end portion of each of the pair of second ridges 40 and 50 has a tapered shape having a shorter length as it is closer to the first input/output terminal 11 in the X-Z plane (third plane) including the central axes of the pair of second ridges 40 and 50.

In addition, similarly to the second input/output end portions 22A and 32A of the pair of ridges 20A and 30A in the circularly polarized wave generator according to the fourth embodiment, a second end portion of each of the pair of second ridges 40 and 50 has a tapered shape having a shorter length as it is closer to the second input/output terminal 12 in the X-Z plane including the central axes of the pair of second ridges 40 and 50.

Furthermore, the pair of first ridges 20 and 30 in the circularly polarized wave generator according to the fifth embodiment may have the following shapes as described in the pair of ridges 20A and 30A in the circularly polarized wave generator according to the fourth embodiment.

That is, the first input/output end portions 21 and 31 in the first ridges 20 and 30 have shapes similar to those of the first input/output end portions 21A and 31A in the ridges 20A and 30A illustrated in the circularly polarized wave generator according to the fourth embodiment, that is, shapes whose heights gradually become shorter as they go from the protruding portions 231a₁ and 331a₁ of the intermediate portions 231 and 331 toward the first input/output terminal 11, respectively.

In addition, the second input/output end portions 22 and 32 in the first ridges 20 and 30 have shapes similar to those of the second input/output end portions 22A and 32A in the ridges 20A and 30A illustrated in the circularly polarized wave generator according to the fourth embodiment, that is, shapes whose heights gradually become shorter as they go from the protruding portions 231a_{N} and 331a_{N} of the intermediate portions 231 and 331 toward the second input/output terminal 12, respectively.

### Sixth Embodiment

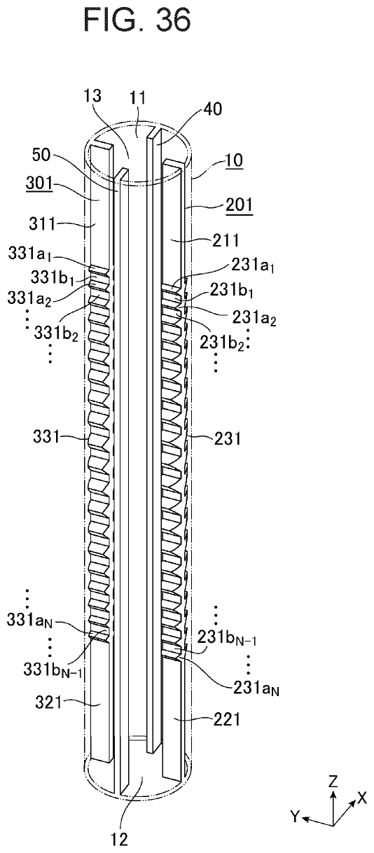

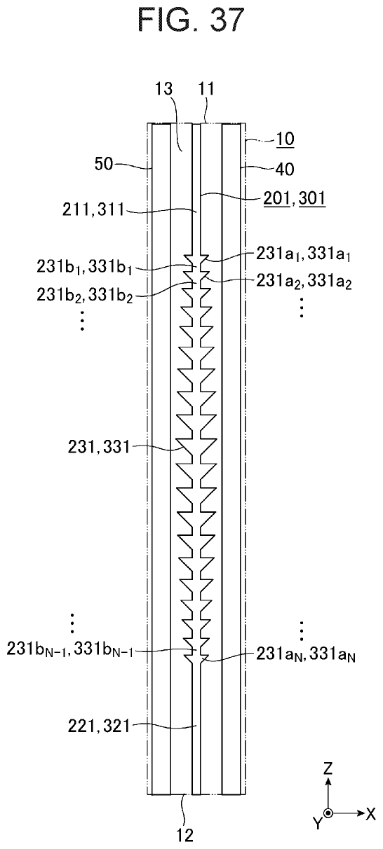

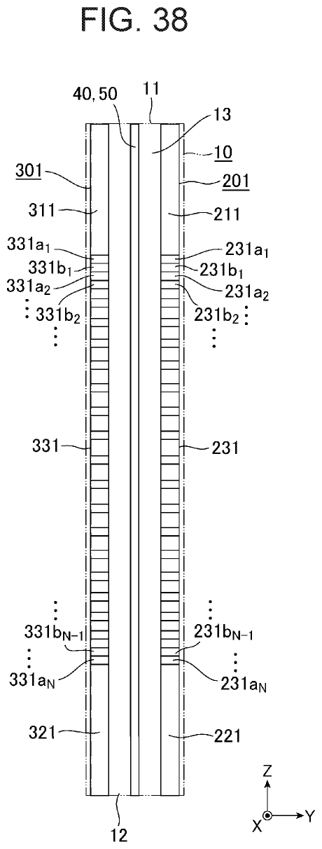

A circularly polarized wave generator according to a sixth embodiment will be described with reference to FIGS. 36 to 38.

The circularly polarized wave generator according to the sixth embodiment is different from the circularly polarized wave generator according to the second embodiment in including a pair of second ridges 40 and 50, and the other points are the same.

In FIGS. 36 to 38, the same reference numerals as in FIGS. 1 to 5 and 17 to 21 denote the same or corresponding portions.

Therefore, hereinafter, the pair of second ridges 40 and 50, which is a different point, will be mainly described.

The circularly polarized wave generator according to the sixth embodiment includes a circular waveguide 10, a pair of first ridges 201 and 301, and the pair of second ridges 40 and 50, and the waveguide 10, the pair of first ridges 201 and 301, and the pair of second ridges 40 and 50 are integrally formed.

Each of the pair of second ridges 40 and 50 has a central axis parallel to a tube axis of the waveguide 10, and the pair of second ridges 40 and 50 are arranged in such a manner as to face each other on an inner wall surface of the waveguide 10 rotated by 90 degrees about the tube axis of the waveguide 10 with respect to the pair of first ridges 201 and 301.

The pair of second ridges 40 and 50 has a symmetrical structure with respect to a second plane (Y-Z plane) passing through the tube axis which is a central axis of the waveguide 10.

The length of each of the pair of second ridges 40 and 50 in a direction along a line connecting the central axes of the pair of second ridges 40 and 50 is uniform over the entire length, and the length thereof in a direction along a line orthogonal to the line connecting the central axes of the pair of second ridges 40 and 50 is uniform over the entire length.

Hereinafter, in the second ridges 40 and 50, the length in the X-axis direction is referred to as a height, the length in the Y-axis direction is referred to as a lateral width, and the length in the Z-axis direction is referred to as a longitudinal width.

That is, in each of the second ridges 40 and 50, the lateral width is uniform over the entire length in the Z-axis direction, and the height is uniform over the entire length in the Z-axis direction as illustrated in FIG. 35 in the fifth embodiment.

A boundary surface between each of the second ridges 40 and 50 and an inner wall surface of the waveguide 10 is an arc surface along the inner wall surface of the waveguide 10 with respect to the Y-Z plane.

A facing surface facing the boundary surface in each of the second ridges 40 and 50 is rectangular and is a plane parallel to the Y-Z plane.

The second ridge 40 and the second ridge 50 have the same size and the same shape.

A lateral width of each of the second ridges 40 and 50 is preferably the same as lateral widths of the first input/output end portions 211 and 311 and lateral widths of the second input/output end portions 221 and 321 in terms of design parameters, but may be different.

A height of each of the second ridges 40 and 50 is preferably the same as heights of the first input/output end portions 211 and 311 and heights of the second input/output end portions 221 and 321 in terms of design parameters, but may be different.

By making the lateral width and height of each of the second ridges 40 and 50 different from those of the first input/output end portions 211 and 311 and the second input/output end portions 221 and 321, the number of design parameters increases, or a more favorable axial ratio characteristic and a more favorable reflection characteristic can be obtained.

Note that, similarly to the manufacture of the circularly polarized wave generator according to the second embodiment, the circularly polarized wave generator according to the sixth embodiment is manufactured by a metal 3D printer having an additive manufacturing technique, and may be manufactured by a resin 3D printer having an additive manufacturing technique and metal plating, die molding, or resin injection molding and metal plating.

The circularly polarized wave generator according to the sixth embodiment has an effect similar to the circularly polarized wave generator according to the second embodiment, has improved symmetry in a cross section parallel to an X-Y plane (first plane) in a waveguide path 13, easily sets a phase difference between two linear polarization signals orthogonal to each other to a desired value, and obtains a more favorable axial ratio characteristic.

Note that the pair of second ridges 40 and 50 in the circularly polarized wave generator according to the sixth embodiment may have the following shapes as described in the pair of ridges 201 and 301 in the circularly polarized wave generator according to the second embodiment.

That is, each of the pair of second ridges 40 and 50 has a first end portion, a second end portion, and an intermediate portion between the first end portion and the second end portion.

Similarly to the intermediate portions of the pair of ridges 201 and 301 in the circularly polarized wave generator according to the second embodiment, the intermediate portions of the pair of second ridges 40 and 50 have a plurality of protruding portions periodically arranged in the tube axis direction of the waveguide 10 and each protruding in a direction along a line connecting the central axes of the pair of first ridges 201 and 301 on the X-Y plane (first plane), and connecting portions connecting adjacent protruding portions in the plurality of protruding portions.

In addition, the pair of second ridges 40 and 50 in the circularly polarized wave generator according to the sixth embodiment may have the following shapes as described in the pair of ridges 20A and 30A in the circularly polarized wave generator according to the fourth embodiment.

That is, each of the pair of second ridges 40 and 50 has a first end portion, a second end portion, and an intermediate portion between the first end portion and the second end portion.

Similarly to the first input/output end portions 21A and 31A of the pair of ridges 20A and 30A in the circularly polarized wave generator according to the fourth embodiment, a first end portion of each of the pair of second ridges 40 and 50 has a tapered shape having a shorter length as it is closer to the first input/output terminal 11 in the X-Z plane (third plane) including the central axes of the pair of second ridges 40 and 50.

In addition, similarly to the second input/output end portions 22A and 32A of the pair of ridges 20A and 30A in the circularly polarized wave generator according to the fourth embodiment, a second end portion of each of the pair of second ridges 40 and 50 has a tapered shape having a shorter length as it is closer to the second input/output terminal 12 in the X-Z plane including the central axes of the pair of second ridges 40 and 50.

Furthermore, the pair of first ridges 201 and 301 in the circularly polarized wave generator according to the sixth embodiment may have the following shapes as described in the pair of ridges 20A and 30A in the circularly polarized wave generator according to the fourth embodiment.

That is, the first input/output end portions 211 and 311 in the first ridges 201 and 301 have shapes similar to those of the first input/output end portions 21A and 31A in the ridges 20A and 30A illustrated in the circularly polarized wave generator according to the fourth embodiment, that is, shapes whose heights gradually become shorter as they go from the protruding portions 231a₁ and 331a₁ of the intermediate portions 231 and 331 toward the first input/output terminal 11, respectively.

In addition, the second input/output end portions 221 and 321 in the first ridges 201 and 301 have shapes similar to those of the second input/output end portions 22A and 32A in the ridges 20A and 30A illustrated in the circularly polarized wave generator according to the fourth embodiment, that is, shapes whose heights gradually become shorter as they go from the protruding portions 231a_{N} and 331a_{N} of the intermediate portions 231 and 331 toward the second input/output terminal 12, respectively.

### Seventh Embodiment

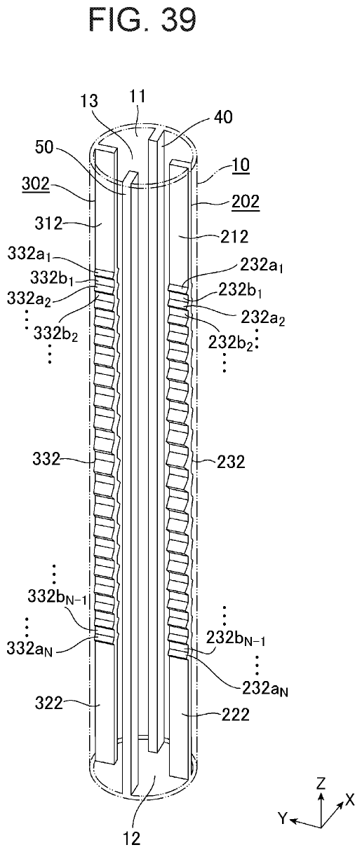

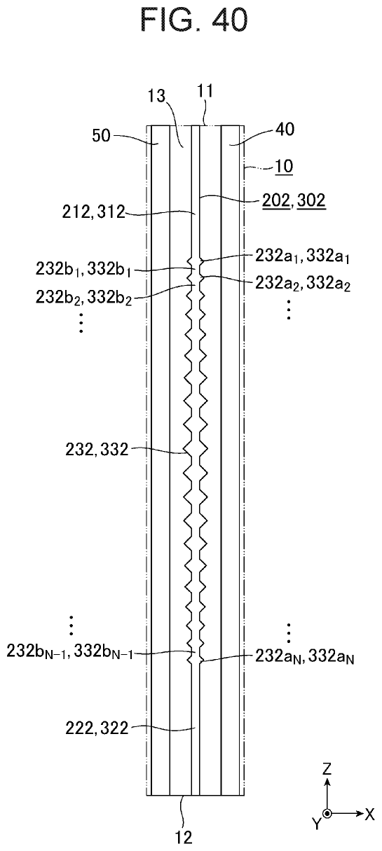

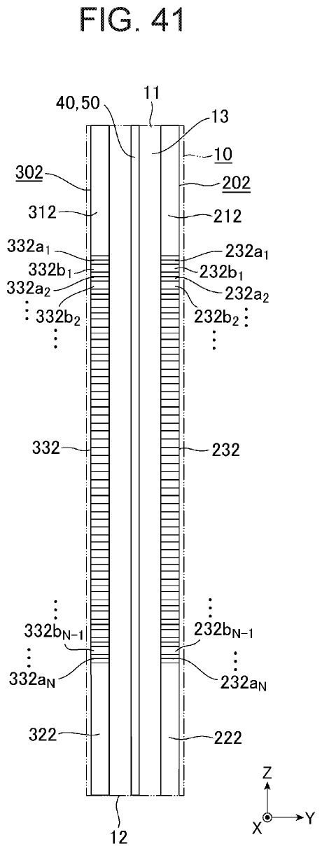

A circularly polarized wave generator according to a seventh embodiment will be described with reference to FIGS. 39 to 41.

The circularly polarized wave generator according to the seventh embodiment is different from the circularly polarized wave generator according to the third embodiment in including a pair of second ridges 40 and 50, and the other points are the same.

In FIGS. 39 to 41, the same reference numerals as in FIGS. 1 to 5 and 22 to 26 denote the same or corresponding portions.

Therefore, hereinafter, the pair of second ridges 40 and 50, which is a different point, will be mainly described.

The circularly polarized wave generator according to the seventh embodiment includes a circular waveguide 10, a pair of first ridges 202 and 302, and the pair of second ridges 40 and 50, and the waveguide 10, the pair of first ridges 202 and 302, and the pair of second ridges 40 and 50 are integrally formed.

Each of the pair of second ridges 40 and 50 has a central axis parallel to a tube axis of the waveguide 10, and the pair of second ridges 40 and 50 are arranged in such a manner as to face each other on an inner wall surface of the waveguide 10 rotated by 90 degrees about the tube axis of the waveguide 10 with respect to the pair of first ridges 202 and 302.

The pair of second ridges 40 and 50 has a symmetrical structure with respect to a second plane (Y-Z plane) passing through the tube axis which is a central axis of the waveguide 10.

The length of each of the pair of second ridges 40 and 50 in a direction along a line connecting the central axes of the pair of second ridges 40 and 50 is uniform over the entire length, and the length thereof in a direction along a line orthogonal to the line connecting the central axes of the pair of second ridges 40 and 50 is uniform over the entire length.

Hereinafter, in the second ridges 40 and 50, the length in the X-axis direction is referred to as a height, the length in the Y-axis direction is referred to as a lateral width, and the length in the Z-axis direction is referred to as a longitudinal width.

That is, in each of the second ridges 40 and 50, the lateral width is uniform over the entire length in the Z-axis direction, and the height is uniform over the entire length in the Z-axis direction as illustrated in FIG. 35 in the fifth embodiment.

A boundary surface between each of the second ridges 40 and 50 and an inner wall surface of the waveguide 10 is an arc surface along the inner wall surface of the waveguide 10 with respect to the Y-Z plane.

A facing surface facing the boundary surface in each of the second ridges 40 and 50 is rectangular and is a plane parallel to the Y-Z plane.

The second ridge 40 and the second ridge 50 have the same size and the same shape.

A lateral width of each of the second ridges 40 and 50 is preferably the same as lateral widths of the first input/output end portions 212 and 312 and lateral widths of the second input/output end portions 222 and 322 in terms of design parameters, but may be different.

A height of each of the second ridges 40 and 50 is preferably the same as heights of the first input/output end portions 212 and 312 and heights of the second input/output end portions 222 and 322 in terms of design parameters, but may be different.

By making the lateral width and height of each of the second ridges 40 and 50 different from those of the first input/output end portions 21 and 31 and the second input/output end portions 22 and 32, the number of design parameters increases, or a more favorable axial ratio characteristic and a more favorable reflection characteristic can be obtained.

Note that, similarly to the manufacture of the circularly polarized wave generator according to the third embodiment, the circularly polarized wave generator according to the seventh embodiment is manufactured by a metal 3D printer having an additive manufacturing technique, and may be manufactured by a resin 3D printer having an additive manufacturing technique and metal plating, die molding, or resin injection molding and metal plating.

The circularly polarized wave generator according to the seventh embodiment has an effect similar to the circularly polarized wave generator according to the third embodiment, has improved symmetry in a cross section parallel to an X-Y plane (first plane) in a waveguide path 13, easily sets a phase difference between two linear polarization signals orthogonal to each other to a desired value, and obtains a more favorable axial ratio characteristic.

Note that the pair of second ridges 40 and 50 in the circularly polarized wave generator according to the seventh embodiment may have the following shapes as described in the pair of ridges 202 and 302 in the circularly polarized wave generator according to the third embodiment.

That is, each of the pair of second ridges 40 and 50 has a first end portion, a second end portion, and an intermediate portion between the first end portion and the second end portion.

Similarly to the intermediate portions of the pair of ridges 202 and 302 in the circularly polarized wave generator according to the third embodiment, the intermediate portions of the pair of second ridges 40 and 50 have a plurality of protruding portions periodically arranged in the tube axis direction of the waveguide 10 and each protruding in a direction along a line connecting the central axes of the pair of first ridges 202 and 302 on the X-Y plane (first plane), and connecting portions connecting adjacent protruding portions in the plurality of protruding portions.

In addition, the pair of second ridges 40 and 50 in the circularly polarized wave generator according to the seventh embodiment may have the following shapes as described in the pair of ridges 20A and 30A in the circularly polarized wave generator according to the fourth embodiment.

That is, each of the pair of second ridges 40 and 50 has a first end portion, a second end portion, and an intermediate portion between the first end portion and the second end portion.

Similarly to the first input/output end portions 21A and 31A of the pair of ridges 20A and 30A in the circularly polarized wave generator according to the fourth embodiment, a first end portion of each of the pair of second ridges 40 and 50 has a tapered shape having a shorter length as it is closer to the first input/output terminal 11 in the X-Z plane (third plane) including the central axes of the pair of second ridges 40 and 50.

In addition, similarly to the second input/output end portions 22A and 32A of the pair of ridges 20A and 30A in the circularly polarized wave generator according to the fourth embodiment, a second end portion of each of the pair of second ridges 40 and 50 has a tapered shape having a shorter length as it is closer to the second input/output terminal 12 in the X-Z plane including the central axes of the pair of second ridges 40 and 50.

Furthermore, the pair of first ridges 202 and 302 in the circularly polarized wave generator according to the seventh embodiment may have the following shapes as described in the pair of ridges 20A and 30A in the circularly polarized wave generator according to the fourth embodiment.

That is, the first input/output end portions 212 and 312 in the first ridges 202 and 302 have shapes similar to those of the first input/output end portions 21A and 31A in the ridges 20A and 30A illustrated in the circularly polarized wave generator according to the fourth embodiment, that is, shapes whose heights gradually become shorter as they go from the protruding portions 231a₁ and 331a₁ of the intermediate portions 231 and 331 toward the first input/output terminal 11, respectively.

In addition, the second input/output end portions 222 and 322 in the first ridges 202 and 302 have shapes similar to those of the second input/output end portions 22A and 32A in the ridges 20A and 30A illustrated in the circularly polarized wave generator according to the fourth embodiment, that is, shapes whose heights gradually become shorter as they go from the protruding portions 231a_{N} and 331a_{N} of the intermediate portions 231 and 331 toward the second input/output terminal 12, respectively.

### Eighth Embodiment

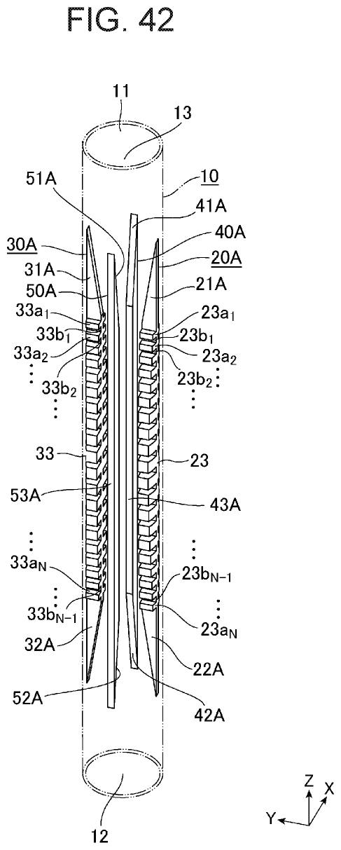

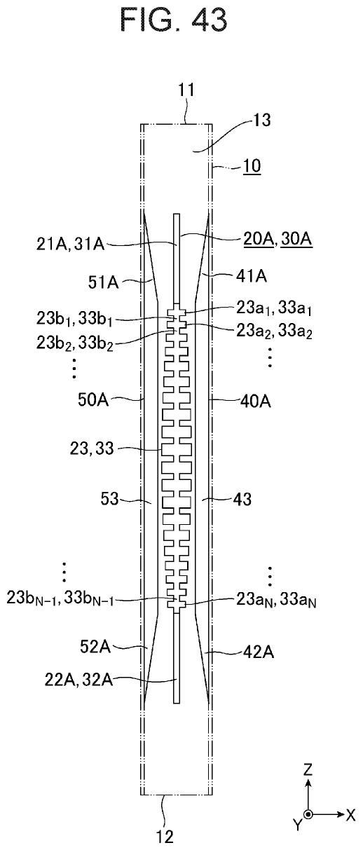

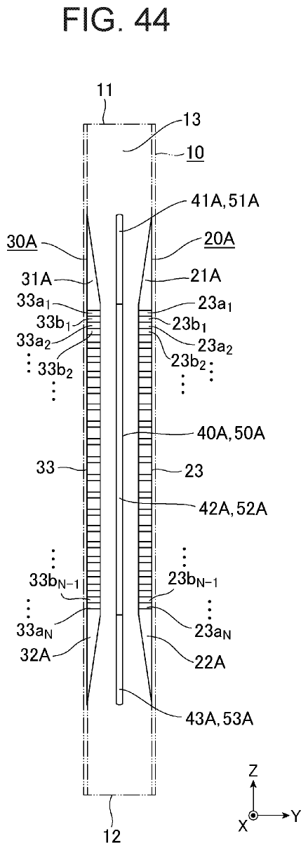

A circularly polarized wave generator according to an eighth embodiment will be described with reference to FIGS. 42 to 46.

The circularly polarized wave generator according to the eighth embodiment is different from the circularly polarized wave generator according to the fourth embodiment in including a pair of second ridges 40A and 50A, and the other points are the same.

In FIGS. 42 to 46, the same reference numerals as in FIGS. 1 to 5 and 27 to 31 denote the same or corresponding portions.

Therefore, hereinafter, the pair of second ridges 40A and 50A, which is a different point, will be mainly described.

The circularly polarized wave generator according to the eighth embodiment includes a circular waveguide 10, a pair of first ridges 20A and 30A, and the pair of second ridges 40A and 50A, and the waveguide 10, the pair of first ridges 20A and 30A, and the pair of second ridges 40A and 50A are integrally formed.

Each of the pair of second ridges 40A and 50A has a central axis parallel to a tube axis of the waveguide 10, and the pair of second ridges 40A and 50A are arranged in such a manner as to face each other on an inner wall surface of the waveguide 10 rotated by 90 degrees about the tube axis of the waveguide 10 with respect to the pair of first ridges 20A and 30A.

The pair of second ridges 40A and 50A has a symmetrical structure with respect to a second plane (Y-Z plane) passing through the tube axis which is a central axis of the waveguide 10.

The pair of second ridges 40A and 50A have first end portions 41A and 51A, second end portions 42A and 52A, and intermediate portions 43A and 53A between the first end portions 41A and 51A and the second end portions 42A and 52A, respectively.

In each of the pair of second ridges 40A and 50A, the first end portions 41A and 51A serve as first input/output end portions, and the second end portions 42A and 52A serve as second input/output end portions.

Hereinafter, in the second ridges 40A and 50A, the length in the X-axis direction is referred to as a height, the length in the Y-axis direction is referred to as a lateral width, and the length in the Z-axis direction is referred to as a longitudinal width.

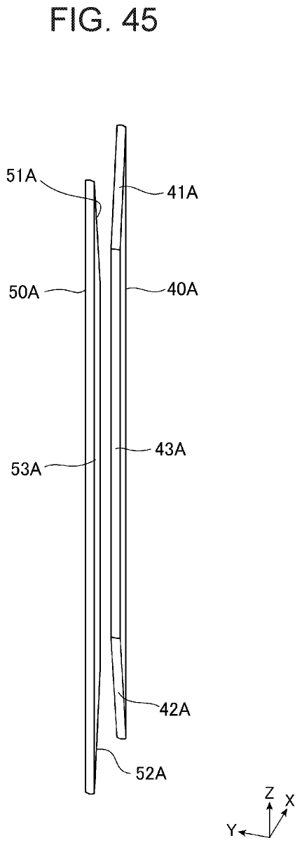

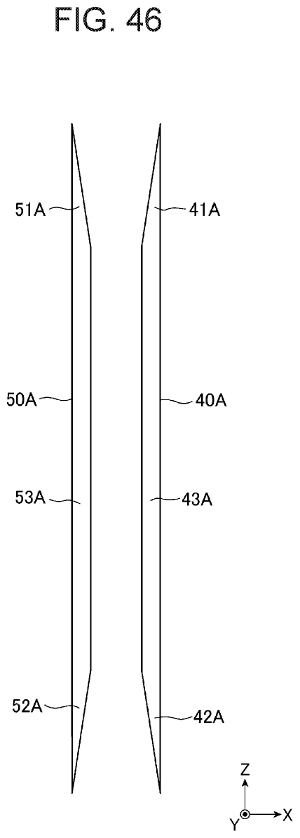

Each of the second ridges 40A and 50A has the following shape, particularly as illustrated in FIGS. 45 and 46.

That is, the first end portions 41A and 51A of the second ridges 40A and 50A have tapered shapes having a shorter length, that is, a shorter height as they go from first ends of the intermediate portions 43A and 53A toward the first input/output terminal 11 on the third plane (X-Z plane) including central axes of the pair of second ridges 40A and 50A, respectively, and have a uniform length, that is, a uniform lateral width in a direction along a line connecting the central axes of the pair of second ridges 40A and 50A.

The second end portions 42A and 52A of the second ridges 40A and 50A have tapered shapes having a shorter height as they go from the second ends of the intermediate portions 43A and 53A toward the second input/output terminal 12, respectively, and have a uniform lateral width.

In the intermediate portions 43A and 53A in the second ridges 40A and 50A, the lateral widths are uniform over the entire length in the Z-axis direction, and the heights are uniform over the entire length in the Z-axis direction, respectively.

A boundary surface between each of the second ridges 40A and 50A and an inner wall surface of the waveguide 10 is an arc surface along the inner wall surface of the waveguide 10 with respect to the Y-Z plane.

A facing surface facing the boundary surface in each of the second ridges 40A and 50A is rectangular, and is a flat surface continuous from the first end portions 41A and 51A to the second end portions 42A and 52A via the intermediate portions 43A and 53A.

The lateral widths of the first end portions 41A and 51A, the intermediate portions 43A and 53A, and the second end portions 42A and 52A are the same.

The second ridge 40A and the second ridge 50A have the same size and the same shape.

The height of each of the second ridges 40A and 50A changes gently when viewed from the first input/output terminal 11 and the second input/output terminal 12, and therefore a more favorable reflection characteristic can be obtained.

Lateral widths of the second ridges 40A and 50A are preferably the same as lateral widths of the first input/output end portions 21A and 31A and lateral widths of the second input/output end portions 22A and 32A in the first ridges 20A and 30A, respectively, in terms of design parameters, but may be different.

In addition, heights of the intermediate portions 43A and 53A in the second ridges 40A and 50A are preferably the same as heights of the first input/output end portions 21A and 31A and heights of the second input/output end portions 22A and 32A in the first ridges 20A and 30A, respectively, in terms of design parameters, but may be different.

By making the lateral width and height of each of the second ridges 40 and 50 different from those of the first input/output end portions 21 and 31 and the second input/output end portions 22 and 32, the number of design parameters increases, or a more favorable axial ratio characteristic and a more favorable reflection characteristic can be obtained.

Similarly to the manufacturing of the circularly polarized wave generator according to the fourth embodiment, the circularly polarized wave generator according to the eighth embodiment is manufactured by die molding.

Note that, as described in the circularly polarized wave generator according to the fourth embodiment, the circularly polarized wave generator according to the eighth embodiment may be manufactured by a metal 3D printer having an additive manufacturing technique, a resin 3D printer having an additive manufacturing technique and metal plating, or resin injection molding and metal plating.

The circularly polarized wave generator according to the eighth embodiment has an effect similar to the circularly polarized wave generator according to the fourth embodiment, has improved symmetry in a cross section parallel to an X-Y plane (first plane) in a waveguide path 13, easily sets a phase difference between two linear polarization signals orthogonal to each other to a desired value, and obtains a more favorable axial ratio characteristic because the height of each of the second ridges 40A and 50A changes gently when viewed from each of the first input/output terminal 11 and the second input/output terminal 12 by making the first end portions 41A and 51A and the second end portions 42A and 52A tapered, respectively.

Note that the intermediate portions 43A and 53A of the pair of second ridges 40A and 50A in the circularly polarized wave generator according to the eighth embodiment may have the following shapes as described in the intermediate portions 23 and 33 of the pair of ridges 20A and 30A in the circularly polarized wave generator according to the fourth embodiment.

That is, similarly to the intermediate portions 23 and 33 of the pair of ridges 20A and 30A in the circularly polarized wave generator according to the fourth embodiment, the intermediate portions 43A and 53A of the pair of second ridges 40A and 50A have a plurality of protruding portions periodically arranged in the tube axis direction of the waveguide 10 and each protruding in a direction along a line connecting the central axes of the pair of first ridges 20A and 30A on the X-Y plane (first plane), and connecting portions connecting adjacent protruding portions in the plurality of protruding portions, respectively.

In addition, each of the plurality of protruding portions 23a₁ to 23a_{N} and 33a₁ to 33a_{N} in the intermediate portions 23 and 33 of the pair of first ridges 20A and 30A in the circularly polarized wave generator according to the eighth embodiment may have a trapezoidal cross section parallel to the third plane (X-Z plane) similarly to the plurality of protruding portions 231a₁ to 231a_{N} and 331a₁ to 331a_{N} in the intermediate portions 231 and 331 of the pair of ridges 201 and 301 in the circularly polarized wave generator according to the second embodiment.

Furthermore, each of the plurality of protruding portions 23a₁ to 23a_{N} and 33a₁ to 33a_{N} in the intermediate portions 23 and 33 of the pair of first ridges 20A and 30A in the circularly polarized wave generator according to the eighth embodiment may have a hexagonal cross section parallel to the X-Z plane similarly to the plurality of protruding portions 232a₁ to 232a_{N} and 332a₁ to 332a_{N} in the intermediate portions 232 and 332 of the pair of ridges 202 and 302 in the circularly polarized wave generator according to the third embodiment.

Note that the embodiments can be freely combined to each other, any constituent element in each of the embodiments can be modified, or any constituent element in each of the embodiments can be omitted.

### INDUSTRIAL APPLICABILITY

The circularly polarized wave generator according to the present disclosure is applied to a circularly polarized wave generator mainly used in a VHF band, a UHF band, a microwave band, and a millimeter wave band, and is suitable for a circularly polarized wave generator connected to a horn antenna having a circular waveguide terminal.

### REFERENCE SIGNS LIST

10: Waveguide, 11: First input/output terminal, 12: Second input/output terminal, 13: Hollow portion, 20, 201 to 203, 30, 301 to 303, 20A, 30A: Ridge, 21, 211 to 213, 31, 311 to 313, 21A, 31A: First input/output end portion, 22, 221 to 223, 32, 321 to 323, 22A, 32A: Second input/output end portion, 23, 231 to 233, 33, 331 to 333: Intermediate portion, 23a₁ to 23a_{N}, 231a₁ to 231a_{N}, 233a₁ to 233a_{N}, 33a₁ to 33a_{N}, 331a₁ to 331a_{N}, 333a₁ to 333a_{N}: Protruding portion, 23b₁ to 23b_{N-1}, 231b₁ to 231b_{N-1}, 233b₁ to 233b_{N-1}, 33b₁ to 33b_{N-1}, 331b₁ to 331b_{N-1}, 33b₁ to 333b_{N-1}: Connecting portion, 40, 50, 40A, 50A: Second ridge

What is claimed is:

1. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein each of the plurality of protruding portions has a rectangular cross section parallel to a third plane orthogonal to a second plane including central axes of the pair of ridges.

2. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein each of the plurality of protruding portions has a trapezoidal cross section parallel to a third plane orthogonal to a second plane including central axes of the pair of ridges.

3. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein each of the plurality of protruding portions has a hexagonal cross section parallel to a third plane orthogonal to a second plane including central axes of the pair of ridges.

4. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein a length of each of the plurality of protruding portions in a direction along a line orthogonal to a line connecting central axes of the pair of ridges becomes shorter as it goes from each of protruding portions at centers of the central axes of the ridges toward each of the first input/output end portion and the second input/output end portion.

5. The circularly polarized wave generator according to claim 1, wherein a length of each of the plurality of protruding portions in a direction along a line orthogonal to a line connecting central axes of the pair of ridges becomes shorter as it goes from each of protruding portions at centers of the central axes of the ridges toward each of the first input/output end portion and the second input/output end portion.

6. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein a length of each of the plurality of protruding portions in a direction along a line orthogonal to a line connecting central axes of the pair of ridges becomes shorter in a trigonometric function shape as it is closer to the first input/output end portion and the second input/output end portion with each of protruding portions at centers of the central axes of the ridges as a vertex.

7. The circularly polarized wave generator according to claim 1, wherein a length of each of the plurality of protruding portions in a direction along a line orthogonal to a line connecting central axes of the pair of ridges becomes shorter in a trigonometric function shape as it is closer to the first input/output end portion and the second input/output end portion with each of protruding portions at centers of the central axes of the ridges as a vertex.

8. A circularly polarized wave generator comprising:
a hollow waveguide having a first input/output terminal at a first end, a second input/output terminal at a second end, and a hollow portion having a circular cross section; and
a pair of ridges each having a central axis parallel to a tube axis of the waveguide and arranged in such a manner as to face each other on an inner wall surface of the waveguide, wherein
each of the pair of ridges has a first input/output end portion at a first end, a second input/output end portion at a second end, and an intermediate portion between the first input/output end portion and the second input/output end portion,
the intermediate portion of each ridge has a plurality of protruding portions periodically arranged in a tube axis direction of the waveguide and protruding in a direction along a line orthogonal to a line connecting central axes of the pair of ridges on a first plane perpendicular to the tube axis of the waveguide, and connecting portions connecting adjacent protruding portions in the plurality of protruding portions,
wherein a length of each of the plurality of protruding portions in a direction along central axes of the ridges becomes shorter as it goes from each of protruding portions at centers of the central axes of the ridges toward the first input/output end portion and the second input/output end portion.

9. The circularly polarized wave generator according to claim 1, wherein a length of each of the plurality of protruding portions in a direction along central axes of the ridges becomes shorter as it goes from each of protruding portions at centers of the central axes of the ridges toward the first input/output end portion and the second input/output end portion.

10. The circularly polarized wave generator according to claim 1, wherein
the first input/output end portion of each of the pair of ridges has a shorter length as it is closer to the first input/output terminal on a second plane including central axes of the pair of ridges, and
the second input/output end portion of each of the pair of ridges has a shorter length as it is closer to the second input/output terminal on the second plane including the central axes of the pair of ridges.

11. The circularly polarized wave generator according to claim 1, comprising a pair of second ridges each of which has a central axis parallel to a tube axis of the waveguide and which are arranged in such a manner as to face each other on an inner wall surface of the waveguide rotated by 90 degrees about the tube axis of the waveguide with respect to the pair of ridges.

12. The circularly polarized wave generator according to claim 11, wherein lengths of the pair of second ridges in a direction along a line connecting central axes of the pair of second ridges are uniform over the entire length, and lengths of the pair of second ridges in a direction along a line orthogonal to the line connecting the central axes of the pair of second ridges are uniform over the entire length.

13. The circularly polarized wave generator according to claim 11, wherein
each of the pair of second ridges has a first end portion, a second end portion, and an intermediate portion between the first end portion and the second end portion,
the intermediate portion in each of the pair of second ridges has a plurality of protruding portions periodically arranged in a tube axis direction of the waveguide and each protruding in a direction along a line connecting central axes of the pair of ridges on the first plane, and connecting portions connecting adjacent protruding portions in the plurality of protruding portions.

14. The circularly polarized wave generator according to claim 11, wherein
each of the pair of second ridges has a first end portion, a second end portion, and an intermediate portion between the first end portion and the second end portion,
a length of the intermediate portion in a direction along a line connecting central axes of the pair of second ridges is uniform over an entire length, and a length of the intermediate portion in a direction along a line orthogonal to the line connecting the central axes of the pair of second ridges is uniform,
a length of the first end portion in a direction along a line orthogonal to a line connecting the central axes of the pair of second ridges becomes shorter as it is closer to the first input/output terminal, and a length of the first end portion in a direction along a line connecting the central axes of the pair of second ridges is uniform, and
a length of the second end portion in a direction along a line orthogonal to a line connecting the central axes of the pair of second ridges becomes shorter as it is closer to the second input/output terminal, and a length of the second end portion in a direction along a line connecting the central axes of the pair of second ridges is uniform.

15. A method for manufacturing the circularly polarized wave generator according to claim 1, the method comprising
performing additive manufacturing by integration from the second input/output terminal toward the first input/output terminal by a 3D printer.
